(19) United States
(12) Patent Application Publication
(10) Pub. No.: US 2008/0152413 A1
(43) Pub. Date: Jun. 26, 2008

(54) Printing Method, Storage Medium Having Program Stored Thereon, and Printing System

(75) Inventors: Masahiko YOSHIDA, Shiojiri-shi (JP); Bunji ISHIMOTO, Matsumoto (JP); Tatsuya NAKANO, Hata-machi (JP); Toru MIYAMOTO, Shiojiri-shi (JP); Hirokazu NUNOKAWA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/951,192

(22) Filed: Dec. 5, 2007

(30) Foreign Application Priority Data
Dec. 20, 2006 (JP) 2006-343136

(51) Int. Cl. B41J 11/44

(52) U.S. Cl. 400/76

(57) ABSTRACT

A test pattern is formed by forming a plurality of dot rows using a first printing in a first printing region and a second printing region, transporting a medium by a predetermined transport amount, and forming a plurality of dot rows using a second printing in the second printing region. Second printing region correction values are obtained based on a reading result of a scanner. Densities of a print image constituted by a plurality of dot rows of the second printing region are corrected by correcting data corresponding to the second printing region correction values based on the second printing region correction values. In such a printing method, when forming the print image, if a transport amount of transport to be carried out between the first printing and the second printing is set shorter than the predetermined transport amount, data corresponding to a portion of correction values of the plurality of second printing region correction values is not corrected based on the portion of the correction values.

### CROSS-REFERENCE TO RELATED APPLICATIONS

The present application claims priority upon Japanese Patent Application No. 2006-343136 filed on Dec. 20, 2006, which is herein incorporated by reference.

### BACKGROUND

1. Technical Field

The present invention relates to printing methods, storage media for storing programs, and printing systems.

2. Related Art

Inkjet printers are known as printing apparatuses in which a medium (such as a paper or cloth, for example) is transported in a transport direction and printing is carried out on the medium by a head. With these printing apparatuses, white streaks or black streaks may occur in an image printed on the medium, and density irregularities may occur.

Accordingly, JP-A-02-54676 proposes a method for correcting the density irregularities.

When acquiring correction values, a test pattern is printed, and the test pattern is read, and the correction values are calculated based on the reading result. When forming a print image thereafter, if the print image is printed in the same way as printing the test pattern, the density irregularities can be corrected by using the correction values as they are.

However, when forming the print image, in the case where the print image is to be printed by carrying out an operation different from that of printing the test pattern, the density irregularities may not be corrected appropriately by using the correction values as they are.

### SUMMARY

An advantage of the present invention is to enable the density irregularities to be corrected appropriately.

A primary aspect of the invention for achieving the foregoing advantage is a printing method that includes: forming a test pattern by forming a plurality of dot rows using a first printing in a first printing region and a second printing region that is positioned at a trailing edge side of a medium from the first printing region, transporting the medium by a predetermined transport amount after the first printing, and forming a plurality of dot rows using a second printing in the second printing region; reading the test pattern with a scanner; obtaining a plurality of second printing region correction values respectively corresponding to the plurality of dot rows formed in the second printing region based on a reading result of the scanner; and correcting densities of a print image constituted by a plurality of dot rows of the second printing region by correcting data corresponding to the second printing region correction values based on the second printing region correction values and forming the dot rows using the first printing and the second printing based on the corrected data, wherein in forming the print image, if a transport amount of transport carried out between the first printing and the second printing is set shorter than the predetermined transport amount, data corresponding to a portion of correction values of the plurality of second printing region correction values is not corrected based on the portion of the correction values.

Other features of the present invention will become clear from the description of the present specification and the accompanying drawings.

### BRIEF DESCRIPTION OF THE DRAWINGS

FIG. 1 is a diagram for describing the configuration of a printing system.

FIG. 2 is a block diagram of the overall configuration of a printer.

FIG. 3A is a schematic diagram showing the overall structure of the printer, and FIG. 3B is a sectional view of the overall configuration of the printer 1.

FIG. 4 is an explanatory diagram showing the arrangement of nozzles on a lower surface of a head.

FIG. 5R is a sectional view of a scanner, and FIG. 5B is a top view of the scanner with an upper cover detached.

FIGS. 6A and 6B are explanatory diagrams of a regular printing, where FIG. 6A shows positions of the head and how dots are formed in pass n through pass n+3, and FIG. 6B shows positions of the head and how dots are formed in pass n through pass n+4.

FIG. 7 is an explanatory diagram for describing leading edge printing and trailing edge printing.

FIG. 8A is an explanatory diagram of a state in which dots are formed in an ideal manner, FIG. 8B is an explanatory diagram of the effects of variation in the process accuracy of the nozzles, and FIG. 8C is an explanatory diagram showing how dots are formed by the printing method of the present embodiment.

FIG. 9 is a flowchart of correction-value acquisition process carried out in an inspection step after the printer is manufactured.

FIG. 10 is an explanatory diagram of a test pattern.

FIG. 11 is an explanatory diagram of a correction pattern.

FIG. 12 is a measurement value table in which the results of measuring the density of five types of band-shaped patterns of cyan are summarized.

FIG. 13 is a graph showing the measurement values of the band-shaped patterns at 30% density, 40% density, and 50% density of cyan.

FIG. 14A is a diagram for describing a target instructed tone value Sbt for the instructed tone value Sb in the row region i, and FIG. 14B is a diagram for describing a target instructed tone value Sbt for the instructed tone value Sb in the row region j.

FIG. 15 is an explanatory diagram of a cyan correction value table.

FIG. 16 is a flowchart of the processes performed by the user.

FIG. 17 is a flowchart of print-data generation process.

FIG. 18 is an explanatory diagram of the density correction process for an n-th row region for cyan.

FIG. 19A is an explanatory diagram of a positional relationship between the head and the trailing edge of the paper when the regular printing is finished in the case of A4 size. FIG. 19B is an explanatory diagram of a positional relationship between the head and the trailing edge of the paper when the regular printing is finished in the case of L size.

FIG. 20A is an explanatory diagram of a case where the trailing edge printing is carried out on A4 size paper. FIG. 20B is an explanatory diagram of a case where the trailing edge printing is carried out on the L size paper without carrying out a positional alignment transport after FIG. 19B.

FIG. 21A is an explanatory diagram of the trailing edge printing in FIG. 20A. FIG. 21B is an explanatory diagram of the trailing edge printing in FIG. 20B.

FIGS. 22A and 22B are explanatory diagrams of the positional alignment transport. FIG. 22A is an explanatory diagram of a case where the trailing edge printing is carried out on the A4 size paper, and is equivalent to FIG. 20A. FIG. 22B is an explanatory diagram of a case where the trailing edge printing is carried out by performing the positional alignment transport for the L size paper.

FIG. 23 is an explanatory diagram of a condition of the trailing edge printing region when the positional alignment transport is carried out.

FIG. 24A is an explanatory diagram of the manner of the trailing edge printing on the A4 size paper. FIG. 24B is an explanatory diagram of the manner of the trailing edge printing on the L size paper.

FIG. 25 shows in its center table a relationship between the 28 raster lines of the “region covered by the correction values for the trailing edge printing region” in FIG. 24B and the nozzles by which each of the raster lines are formed. A table on the right side shows a relationship between the correction values for the regular printing region and the nozzles. A table on the left side shows a relationship between the correction values for the trailing edge printing region and the nozzles.

### DESCRIPTION OF EXEMPLARY EMBODIMENTS

At least the following matters will be made clear by the description of the present specification and the accompanying drawings.

A printing method is made clear that includes:

forming a test pattern by forming a plurality of dot rows using a first printing in a first printing region and a second printing region that is positioned at a trailing edge side of a medium from the first printing region, transporting the medium by a predetermined transport amount after the first printing, and forming a plurality of dot rows using a second printing in the second printing region;

reading the test pattern with a scanner;

obtaining a plurality of second printing region correction values respectively corresponding to the plurality of dot rows formed in the second printing region based on a reading result of the scanner; and

correcting densities of a print image constituted by a plurality of dot rows of the second printing region by correcting data corresponding to the second printing region correction values based on the second printing region correction values and forming the dot rows using the first printing and the second printing based on the corrected data,

wherein in forming the print image, if a transport amount of transport carried out between the first printing and the second printing is set shorter than the predetermined transport amount, data corresponding to a portion of correction values of the plurality of second printing region correction values is not corrected based on the portion of the correction values.

With such printing method, density irregularities can be corrected appropriately.

Furthermore, it is preferable that the transport amount of transport to be carried out between the first printing and the second printing becomes shorter than the predetermined transport amount corresponding to a size of a medium on which the print image is to be formed. This printing method is particularly effective in such case. Furthermore, it is preferable that a transport member for transporting the medium is included, wherein a positional relationship between the medium and the transport member when the second printing is finished in forming the print image is identical regardless of the size of the medium. In this way, the image quality of the second printing region is kept stable regardless of the size of the paper.

Furthermore, it is preferable that the number of the portion of the correction values increases as the transport amounts of transport to be carried out between the first printing and the second printing become shorter than the predetermined transport amount. In this way, the density irregularities can be corrected appropriately.

Furthermore, it is preferable that first printing region correction values corresponding to dot rows formed in the first printing region are obtained based on the reading result of the scanner, and data corresponding to the portion of the correction values is corrected based on the first printing region correction values instead of the portion of the correction values. In this way, the density irregularities can be corrected appropriately.

It is preferable that the portion of the correction values are the correction values corresponding to dot rows positioned on the first printing region side of a plurality of dot rows formed in the second printing region. In this way, the density irregularities can be corrected appropriately.

A storage medium storing a program is made clear, which makes a printing apparatus form a test pattern by forming a plurality of dot rows using a first printing in a first printing region and a second printing region that is positioned at a trailing edge side of a medium from the first printing region, transport the medium by a predetermined transport amount after the first printing, and form a plurality of dot rows by a second printing in the second printing region;

makes a scanner read the test pattern;

makes a control device that controls the printing apparatus obtain a plurality of second printing region correction values respectively corresponding to the plurality of dot rows formed in the second printing region based on a reading result of the scanner; and

makes the control device correct densities of a print image constituted by a plurality of dot rows of the second printing region by correcting data corresponding to the second printing region correction values based on the second printing region correction values and form the dot rows using the first printing and the second printing based on the corrected data,

wherein in forming the print image, if a transport amount of transport carried out between the first printing and the second printing is set shorter than the predetermined transport amount by the printing apparatus, data corresponding to a portion of correction values of the plurality of second printing region correction values is not corrected based on the portion of the correction values.

With such a storage medium storing a program, the density irregularities can be corrected appropriately.

A printing system is made clear, which is provided with:

a printing apparatus, a scanner, and a control device that controls the printing apparatus,

wherein, the printing apparatus forms a test pattern by forming a plurality of dot rows using a first printing in a first printing region and a second printing region that is positioned at a trailing edge side from the first printing region, transporting a medium by a predetermined transport amount after the first printing, and forming a plurality of dot rows using a second printing in the second printing region,

the scanner reads the test pattern,

the control device obtains a plurality of second printing region correction values respectively corresponding to the plurality of dot rows formed in the second printing region based on a reading result of the scanner, and

the control device corrects data corresponding to the second printing region correction values based on the second printing region correction values, and the printing apparatus corrects densities of a print image constituted by a plurality of dot rows of the second printing region by forming the dot rows using the first printing and the second printing based on the corrected data,

wherein, in forming the print image, when a transport amount of transport to be carried out between the first printing and the second printing in the printing apparatus is set shorter than the predetermined transport amount, data corresponding to a portion of correction values of the plurality of second printing region correction values is not corrected based on the portion of the correction values.

With this printing system, the density irregularities can be corrected appropriately.

### Configuration of Printing System

Printing System

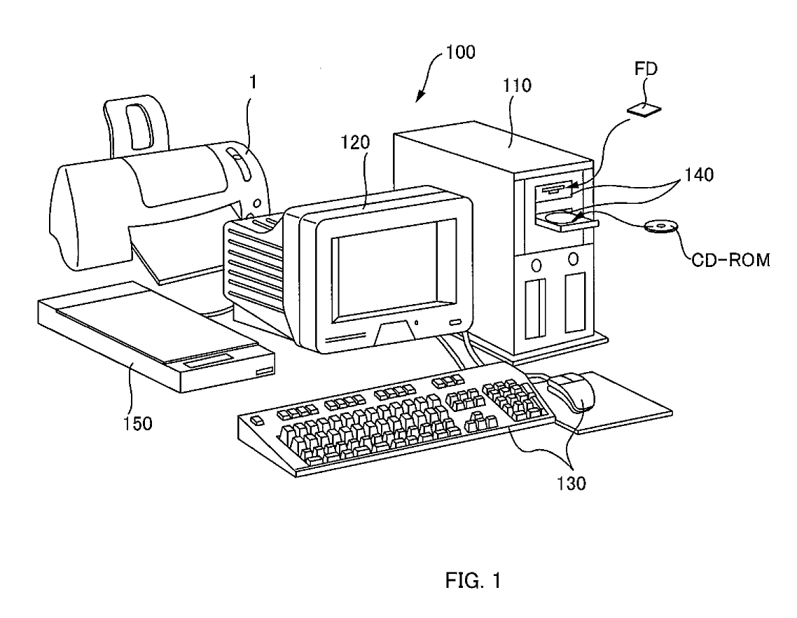

FIG. 1 is a diagram for describing the configuration of a printing system 100. The printing system consists of at least a printing apparatus and a print-control apparatus that controls operations of the printing apparatus. The printing system 100 of the present embodiment is provided with a printer 1, a computer 110, a display device 120, input devices 130, record/play devices 140, and a scanner 150.

The printer 1 is for printing images on a medium such as paper, cloth, film, and OHP film. The computer 110 is communicably connected to the printer 1. In order to make the printer 1 print an image, the computer 110 outputs print data corresponding to that image to the printer 1. This computer 110 has computer programs, such as an application program and a printer driver, installed thereon. A scanner driver is also installed on the computer 110 and is for controlling the scanner 150 and for receiving image data of a document read by the scanner 150.

Printer

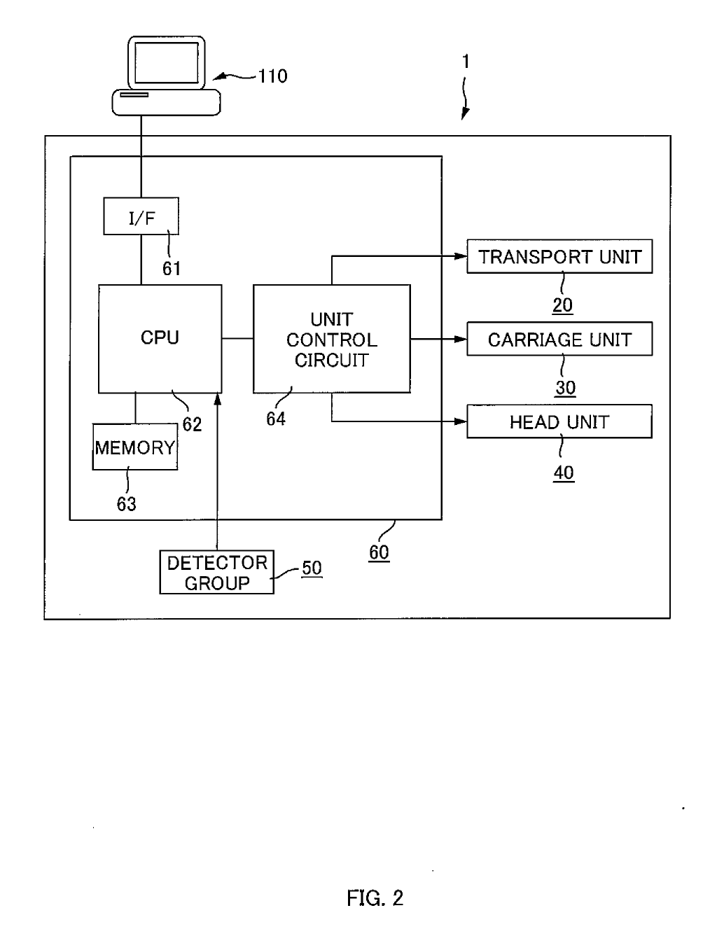

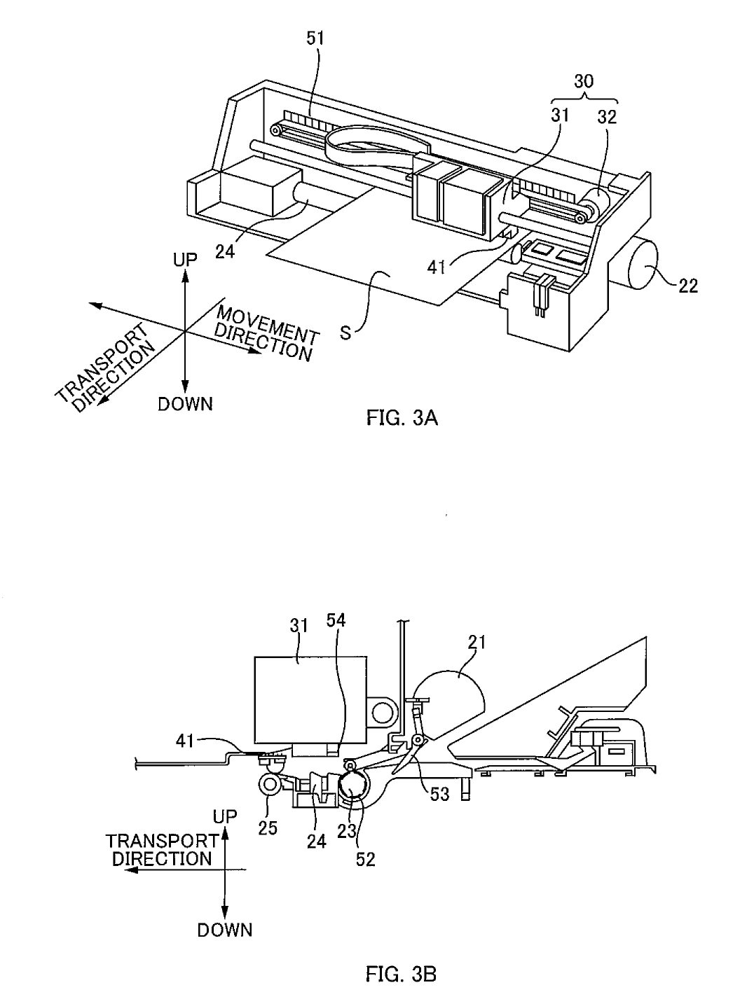

FIG. 2 is a block diagram that shows the overall configuration of the printer 1. FIG. 3A is a schematic diagram showing the overall structure of the printer 1. FIG. 3B is a sectional view of the overall structure of the printer 1. The basic structure of the printer according to the present embodiment is described below.

The printer 1 has a transport unit 20, a carriage unit 30, a head unit 40, a detector group 50, and a controller 60. The printer 1 receives print data from the computer 110, which is an external device, and controls the various units (the transport unit 20, the carriage unit 30, and the head unit 40) through the controller 60. The controller 60 controls these units based on the print data received from the computer 110 to print an image on the paper. The detector group 50 monitors the conditions within the printer 1, and outputs the result of this detection to the controller 60. The controller 60 controls these units based on this detection result received from the detector group 50.

The transport unit 20 is for transporting a medium such as paper in a predetermined direction (hereinafter, referred to as the transport direction). The transport unit 20 has a paper supply roller 21, a transport motor 22 (also referred to as “PF motor”), a transport roller 23, a platen 24, and a paper discharge roller 25. The paper supply roller 21 is a roller for supplying, into the printer, paper that has been inserted into a paper insert opening. The transport roller 23 is a roller for transporting a paper S that has been supplied by the paper supply roller 21 up to a printable region, and is driven by the transport motor 22. The platen 24 supports the paper S being printed. The paper discharge roller 25 is a roller for discharging the paper S outside the printer, and is provided on the downstream side in the transport direction with respect to the printable region. The paper discharge roller 25 is rotated in synchronization with the transport roller 23.

The carriage unit 30 is for making a head move (also referred to as “scan”) in a predetermined direction (hereinafter, referred to as the movement direction). The carriage unit 30 has a carriage 31 and a carriage motor 32 (also referred to as “CR motor”). The carriage 31 can be moved back and forth in the movement direction. The carriage 31 detachably holds ink cartridges that contain ink. The carriage motor 32 is a motor for moving the carriage 31 in the movement direction.

The head unit 40 is for ejecting ink onto the paper. The head unit 40 has a head 41. The head 41 has a plurality of nozzles and intermittently ejects ink from those nozzles. The head 41 is provided in the carriage 31. Thus, when the carriage 31 moves in the movement direction, the head 41 also moves in the movement direction. Dot rows (raster lines) are formed on the paper along the movement direction due to the head 41 intermittently ejecting ink while moving in the movement direction.

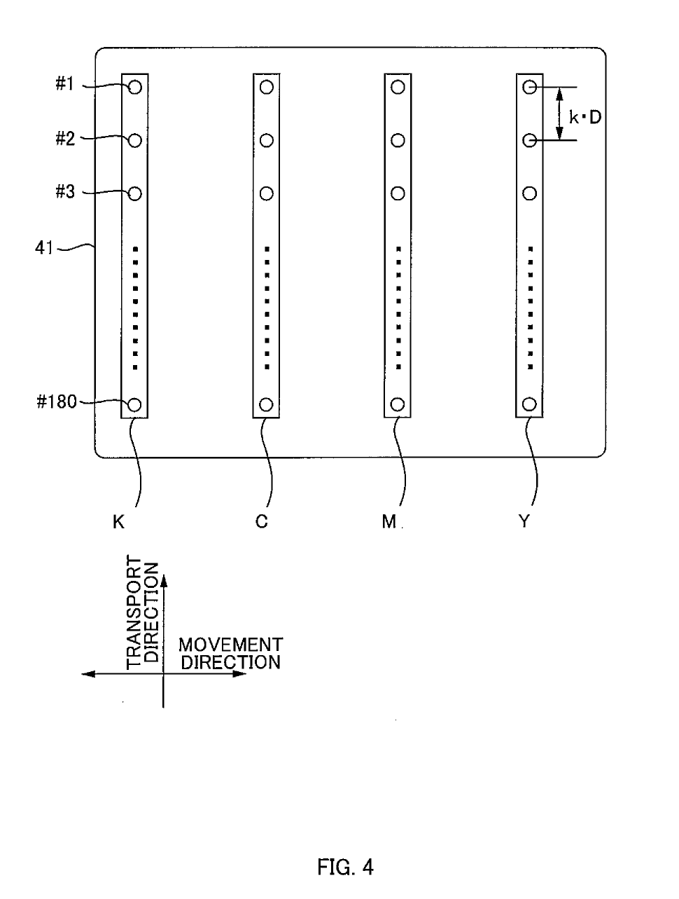

FIG. 4 is an explanatory diagram showing the arrangement of the nozzles in the lower surface of the head 41. A black ink nozzle group K, a cyan ink nozzle group C, a magenta ink nozzle group M, and a yellow ink nozzle group Y are formed in the lower surface of the head 41. Each nozzle group is provided with a plurality of nozzles, which are ejection openings for ejecting ink of the respective colors. The plurality of nozzles of each of the nozzle groups are arranged in rows at a constant spacing (nozzle pitch: k·D) along the transport direction. Here, D is the minimum dot pitch in the transport direction (that is, the spacing between dots formed on the paper S at maximum resolution). Further, k is an integer of 1 or more. For example, if the nozzle pitch is 180 dpi ( 1/180 inch), and the dot pitch in the transport direction is 720 dpi ( 1/720 inch), then k=4. Each nozzle of each of the nozzle groups is assigned a number (#1 to #180) that becomes smaller as the nozzle is arranged more downstream. Each nozzle is provided with an ink chamber (not shown) and a piezo element (not shown). Driving the piezo element causes the ink chamber to expand and contract, thereby ejecting an ink droplet from the nozzle.

The detector group 50 includes a linear encoder 51, a rotary encoder 52, a paper detection sensor 53, an optical sensor 54, and the like. The linear encoder 51 is for detecting the position of the carriage 31 in the movement direction. The rotary encoder 52 is for detecting the amount of rotation of the transport roller 23. The paper detection sensor 53 is for detecting the position of the leading edge of the paper to be printed. The optical sensor 54 is attached to the carriage 31. The optical sensor 54 detects whether or not the paper is present, through its light-receiving section detecting the reflected light of the light that has been irradiated onto the paper from its light-emitting section.

The controller 60 is a control section for carrying out control of the printer. The controller 60 includes an interface section 61, a CPU 62, a memory 63, and a unit control circuit 64. The interface section 61 is for exchanging data between the computer 110, which is an external device, and the printer 1. The CPU 62 is a processing unit for carrying out overall control of the printer. The memory 63 is for ensuring a working area and a storage area for the programs for the CPU 62, for instance, and includes storage devices such as a RAM or an EEPROM. The CPU 62 controls the various units via the unit control circuit 64 in accordance with programs stored in the memory 63.

Scanner

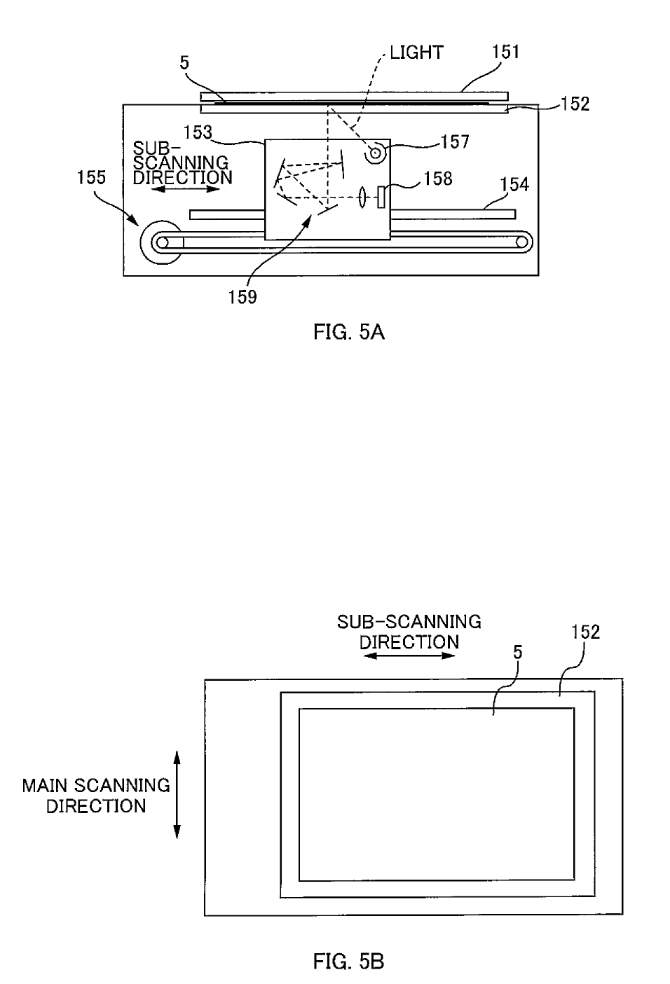

FIG. 5A is a vertical sectional view of the scanner 150. FIG. 5B is a plan view of the scanner 150 with its upper cover 151 detached.

The scanner 150 is provided with the upper cover 151, a document platen glass 152 on which a document 5 is placed, a reading carriage 153 that faces the document 5 through the document platen glass 152 and that moves in a sub-scanning direction, a guiding member 154 that guides the reading carriage 153 in the sub-scanning direction, a moving mechanism 155 for moving the reading carriage 153, and a scanner controller (not shown) that controls the various units of the scanner 150. The reading carriage 153 has an exposure lamp 157 that shines light on the document 5, a line sensor 158 that detects a line image in a main scanning direction (in FIG. 5A, the direction normal to the surface of the paper on which the figure is described), and optical devices 159 that lead the reflected light from the document 5 to the line sensor 158. Dashed lines in the reading carriage 153 shown in FIG. 5A show the path of light.

In order to read an image of the document 5, an operator raises the upper cover 151, places the document 5 on the document platen glass 152, and lowers the upper cover 151. The scanner controller moves the reading carriage 153 along the sub-scanning direction with the exposure lamp 157 emitting light, and the line sensor 158 reads the image on a surface of the document 5. The scanner controller transmits the read image data to the scanner driver installed on the computer 110, and thereby, the computer 110 acquires the image data of the document 5.

### Printing Method

Regarding Printing Operation

When the printer 1 carries out printing, first a paper is supplied to a print start position, then a dot forming process and a transport process are repeated alternately.

Here, the dot forming process is a process for forming dots on the paper by ejecting ink intermittently from the head 41 that moves along the movement direction. The controller 60 moves the carriage 31 in the movement direction by driving the carriage motor 32, and then, while the carriage 31 is moving, causes the head 41 to eject ink in accordance with pixel data contained in the print data. Dots are formed on the paper when ink droplets ejected from the head 41 land on the paper. Since ink is intermittently ejected from the head 41 that is moving, dot rows (raster lines) consisting of a plurality of dots along the movement direction are formed on the paper.

The transport process is a process for moving the paper relative to the head along the transport direction. The controller 60 transports the paper in the transport direction by rotating the transport roller 23. Due to this transport process, the head 41 can form dots at positions that are different from the positions of the dots formed in the preceding dot forming process, in the next dot forming process.

A print image is gradually formed on the paper by alternately repeating the dot forming process and the transport process. When forming of the print image on the paper is finished, the paper is discharged and the printing operation is finished.

Regarding Formation of Raster Lines

First, a regular printing is described. The regular printing of the present embodiment is carried out using a printing mode referred to as interlaced printing. Here, “interlaced printing” means a printing scheme in which raster lines that are not recorded are sandwiched between raster lines that are recorded in one pass. A “pass” refers to one dot forming process, and “pass” refers to the n-th dot forming process.

A “raster line” refers to a row of dots lined up in the movement direction and is also referred to as “dot line”.

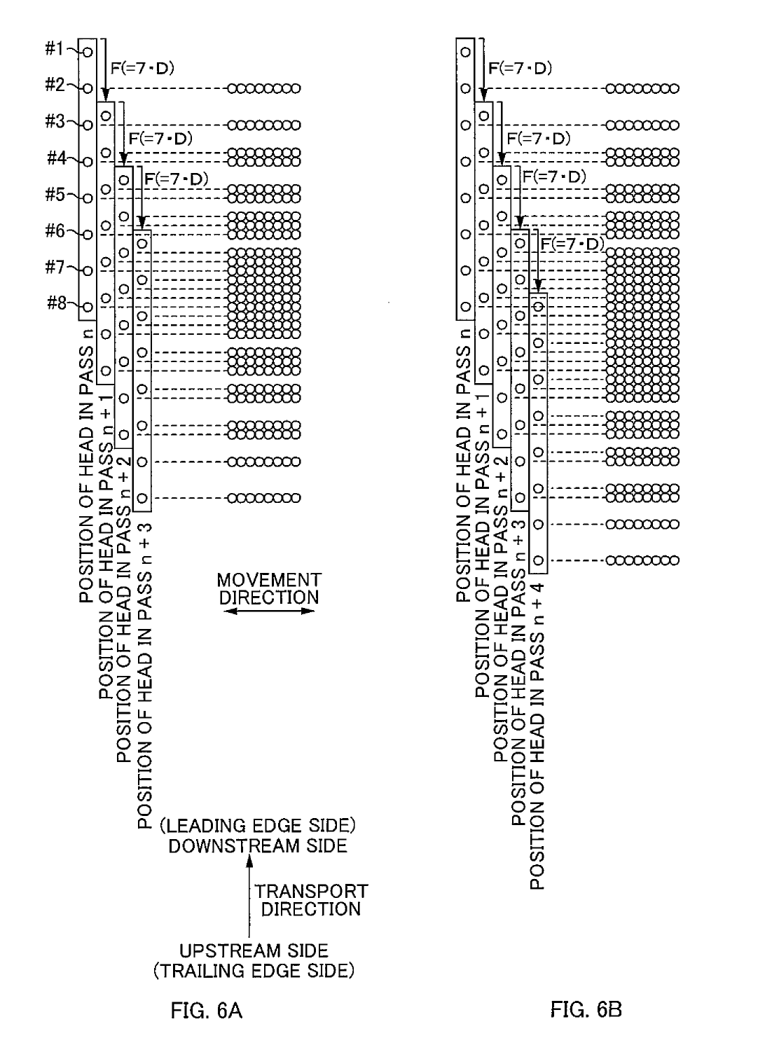

FIGS. 6A and 6B are explanatory diagrams of regular printing. FIG. 6A shows positions of the head and how dots are formed in each of the pass n through pass n+3, and FIG. 6B shows positions of the head and how dots are formed in each of the pass n through pass n+4.

It should be noted that, for convenience's sake, only one of a plurality of the nozzle groups is shown and the number of nozzles of each nozzle group is reduced. In addition, the head 41 (and the nozzle groups) is illustrated as if it is moving with respect to the paper, but the figures merely show the relative positional relationship between the head 41 and the paper, and in reality, the paper moves in the transport direction. Furthermore, for convenience of explanation, each nozzle is illustrated as if it forms only a few dots (circles in the figure), but in reality, there are numerous dots lined up in the movement direction (this row of dots is the raster line) because ink droplets are intermittently ejected from the nozzles that move in the movement direction. As a matter of course, there are cases in which a dot is not formed depending on the pixel data.

In the figure, a nozzle shown with a black circle is a nozzle that can eject ink and a nozzle shown with a white circle is a nozzle that can not eject ink. Furthermore, in the figure, a dot shown with a black circle is a dot that is formed in the last pass and a dot shown with a white circle is a dot that is formed in other passes therebefore.

In this interlaced printing, every time the paper is carried in the transport direction by a constant transport amount F, each nozzle records a raster line immediately above another raster line that was recorded in the immediately prior pass. In order to carry out recording with a constant transport amount in this way, it is required {1) that the number N (integer) of nozzles that can eject ink is coprime to k and (2) that the transport amount F is set to N·D. Here, N=7, k=4, and F=7·D (D= 1/720 inch).

However, there is a region in which raster lines cannot be formed continuously in the transport direction in the case of using only this regular printing. Therefore, printing modes which are respectively referred to as leading edge printing and trailing edge printing are carried out respectively before or after the regular printing.

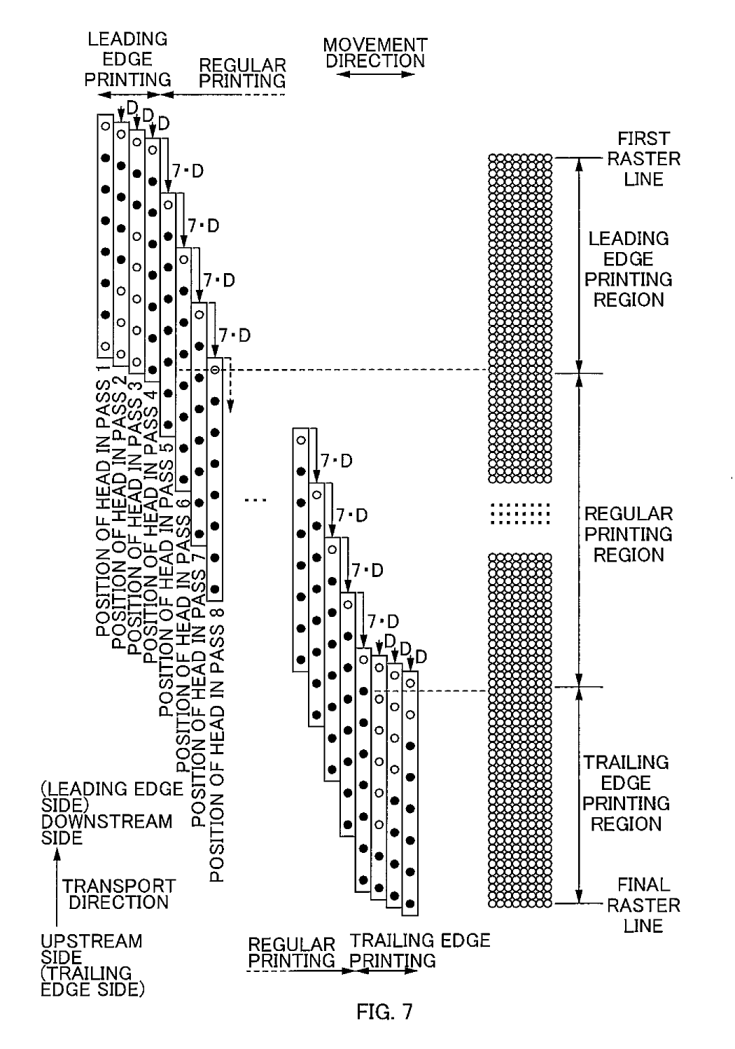

FIG. 7 is an explanatory diagram for describing leading edge printing and trailing edge printing. The first four passes correspond to the leading edge printing, and the last four passes correspond to the trailing edge printing.

In the leading edge printing, at the time when a part near the leading edge of the print image is printed, the paper is carried by a smaller transport amount (1·D) than the transport amount in the regular printing (7·D). In the trailing edge printing, in the same way as the leading edge printing, at the time when a part near the trailing edge of the print image is printed, the paper is carried by a smaller transport amount (1·D) than the transport amount in the regular printing (7·D). In this way, a plurality of raster lines lined up continuously in the transport direction can be formed between the first raster line and the final raster line.

In the case where a certain raster line can be formed by either the regular printing or the leading edge printing, it is formed by the regular printing. Therefore, for example, nozzle #4 of pass 3 in FIG. 7 has the same position in the transport direction opposing the paper as nozzle #2 of pass 5, and therefore it does not form a raster line. Similarly, in the case where a certain raster line can be formed by either the regular printing or the trailing edge printing, it is formed by the regular printing. In this way, printing is carried out with priority given to the regular printing over both the leading edge side and the trailing edge side.

A region in which raster lines are formed solely by the regular printing is referred to as a “regular printing region”. A region which is located on the leading edge side of the paper (the downstream side in the transport direction) with respect to the regular printing region is referred to as a “leading edge printing region”. A region which is located on the trailing edge side of the paper (the upstream side in the transport direction) with respect to the regular printing region is referred to as a “trailing edge printing region”. In the leading edge printing region, 28 raster lines are formed. Also, in the trailing edge printing region, 28 raster lines are formed. In the regular printing region, thousands of raster lines are formed, depending on the size of the paper.

There is regularity in how the raster lines are arranged in the regular printing region, for each set of raster lines of the number corresponding to the transport amount (seven in this example). The raster lines from the first one through the seventh one located in the regular printing region shown in FIG. 7 are formed respectively by nozzle #3, nozzle #5, nozzle #7, nozzle #2, nozzle #4, nozzle #6, and nozzle #8, and the next seven raster lines from the eighth raster line onward are formed by the nozzles in the same order as mentioned above. On the other hand, there is no simple regularity in how the raster lines are arranged in the leading edge printing region and trailing edge printing region, in comparison with the raster lines in the regular printing region.

### Outline of Correction of Density Irregularities

Regarding Density Irregularities (Banding)

In this section, for convenience of explanation, a cause of density irregularities that occurs in an image printed with monochrome printing is described. In the case of multi-color printing, the cause of density irregularities described below occurs for each color.

In the explanation below, a “unit region” means a virtual rectangular region determined on a medium such as paper, the size and shape of which are determined according to the print resolution. For example, in the case that the print resolution is specified as 720 dpi (in the movement direction)×720 dpi (in the transport direction), the unit region is a square region of approximately 35.28 m×35.28 μm (≈ 1/720 inch× 1/720 inch). In the case that the print resolution is 360 dpi×720 dpi, the unit region is a rectangular region of approximately 70.56 μm×35.28 μm (≈ 1/360 inch× 1/720 inch). If an ink droplet is ideally ejected, the ink droplet lands in the center of this unit region, then the ink droplet spreads on the medium, and a dot is formed in the unit region. It should be noted that a single unit region is a region on the paper corresponding to a single pixel that constitutes the image data. Since a pixel is associated with each unit region, the pixel data of each pixel is also associated with each unit region.

Furthermore, in the explanation below, a “row region” means a region consisting of a plurality of unit regions lined up in the movement direction. For example, in the case that the print resolution is 720 dpi×720 dpi, a row region is a band-shaped region having a width of 35.28 μm (≈ 1/720 inch) in the transport direction. If ink droplets are ideally ejected intermittently from a nozzle moving in the movement direction, a raster line is formed in this row region. A plurality of pixels lined up in the movement direction are associated with the row region.

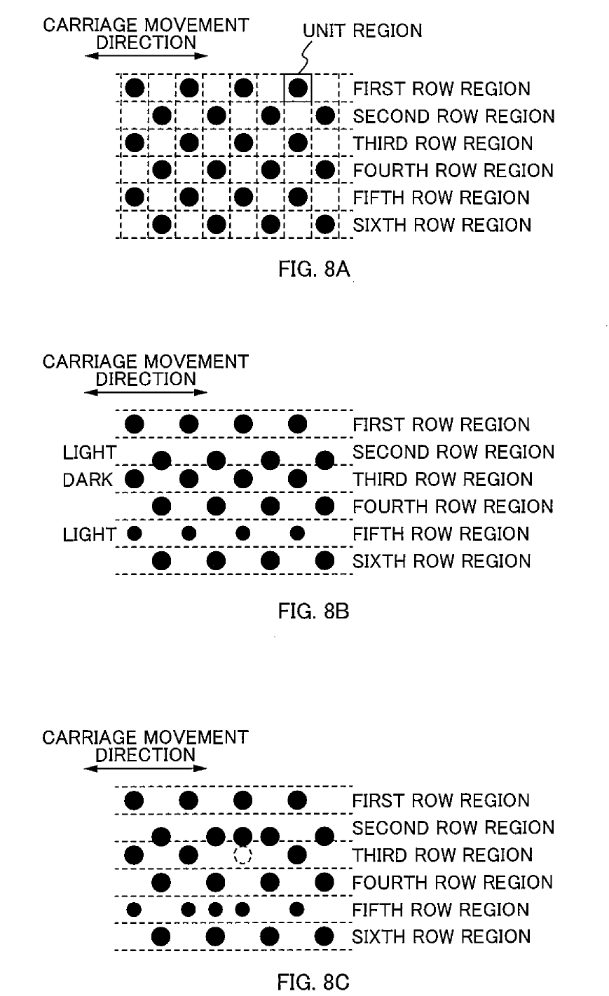

FIG. 8A is an explanatory diagram showing a state in which dots are formed ideally. In the figure, since dots are formed ideally, each dot is formed precisely in the unit region and each raster line is formed precisely in the row region. Each row region is illustrated in the figure as a region sandwiched by dotted lines, and in this case, is a region with a width of 1/720 inch. In each row region, an image piece which has a density equivalent to the coloring of the region is formed. Here, for simplification of explanation, an image which has such a constant density that the dot-generation rate becomes 50% is printed.

FIG. 8B is an explanatory diagram showing the effects of variance in the processing accuracy of the nozzles. Here, the raster line formed in the second row region is formed closer to the side of the third row region (the upstream side in the transport direction) because of variations in the flying direction of ink droplets ejected from nozzles. Also, since the amount of ink of ink droplets ejected to the fifth row region is small, dots formed in the fifth row region are small.

Although originally image pieces having the same density are supposed to be formed in each row region, differences in density occur in the image pieces depending on the row region because of the variation in the processing accuracy. For example, the image piece in the second row region is formed relatively light in color, and the image piece in the third row region is formed relatively dark in color. The image piece in the fifth row region is formed relatively light in color.

Accordingly, when macroscopically observing a printed image consisting of such raster lines, streaky density irregularities along the movement direction of the carriage become visually noticeable. These density irregularities are a cause of reducing the image quality in the printed image.

FIG. 8C is an explanatory diagram showing dots formed by the printing method of the present embodiment. In the present embodiment, for row regions which tend to be visually recognized dark, the tone values of pixel data (CMYK pixel data) of pixels corresponding to those row regions are corrected in order to form lighter image pieces. Also, for row regions which tend to be visually recognized light, the tone values of pixel data of pixels corresponding to those row regions are corrected in order to form darker image pieces. For example, in the figure, the tone values of pixel data of the pixels corresponding to each row region are corrected in order to increase the generation rate of dots in the second row region, to decrease the generation rate of dots in the third row region, and to increase the generation rate of dots in the fifth row region. Thereby, the dot-generation rate of the raster line corresponding to each row region is changed, the density of the image piece in the row region is corrected, and thus density irregularities in the entire printed image are suppressed.

Furthermore, in FIG. 8B, the density of the image piece formed in the third row region becomes darker not because of the effect of the nozzle that forms the raster line in the third row region, but because of the effect of the nozzle that forms the raster line in the adjacent second row region. Accordingly, if the nozzle that forms the raster line in the third row region forms a raster line in another row region, an image piece formed in another row region is not always formed dark. In short, there are cases where there is a difference in density even among image pieces formed by the same nozzle if nozzles that form image pieces adjacent to the above-mentioned pieces are different. In such a case, density irregularities cannot be suppressed merely by correction values corresponding to that nozzle. Thus, in the present embodiment, the tone values of pixel data are corrected based on the correction values set for each row region.

Therefore, in the present embodiment, in the inspection process at a printer manufacturing factory, the printer is caused to print a correction pattern, the correction pattern is read with the scanner, and correction values corresponding to the respective row regions, based on density of each row region in the correction pattern, are stored in a memory of the printer. The correction values stored in the printer reflect characteristics of density irregularities of each individual printer.

Then, under instructions by a user who has purchased the printer, the printer driver reads the correction values from the printer, tone values of pixel data are corrected based on the correction values, print data is generated based on the corrected tone values, and the printer performs printing based on the print data.

Regarding Process in Printer Manufacturing Factory

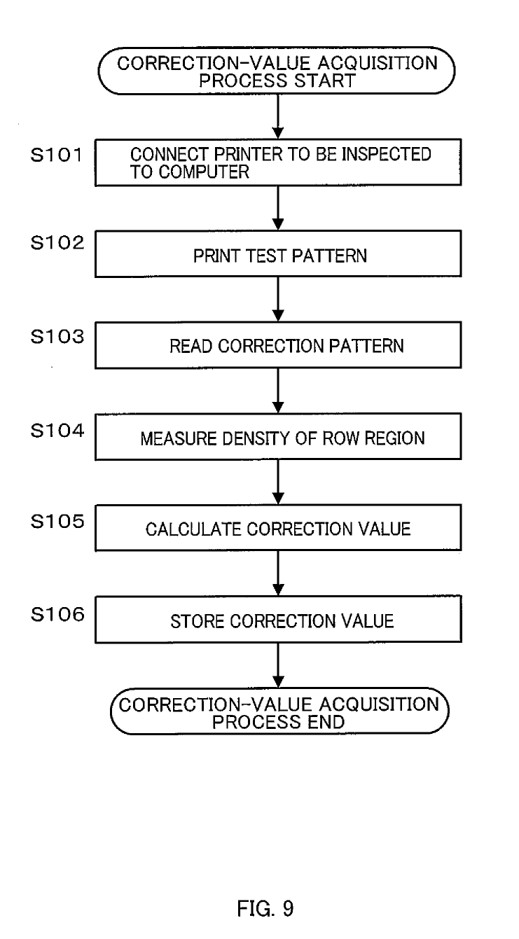

FIG. 9 is a flowchart of correction-value acquisition process carried out during an inspection step after the printer has been manufactured.

First, an inspector connects a printer 1 to be inspected to a computer 110 in a factory (S101). The computer 110 in the factory is also connected to a scanner 150, and a printer driver for making the printer 1 print a test pattern, a scanner driver for controlling the scanner 150, and a program for obtaining correction values for performing image processing, analysis, and so forth, on the image data of the correction pattern read by the scanner are installed on the computer 110.

Next, the printer driver of the computer 110 makes the printer 1 print a test pattern (S102).

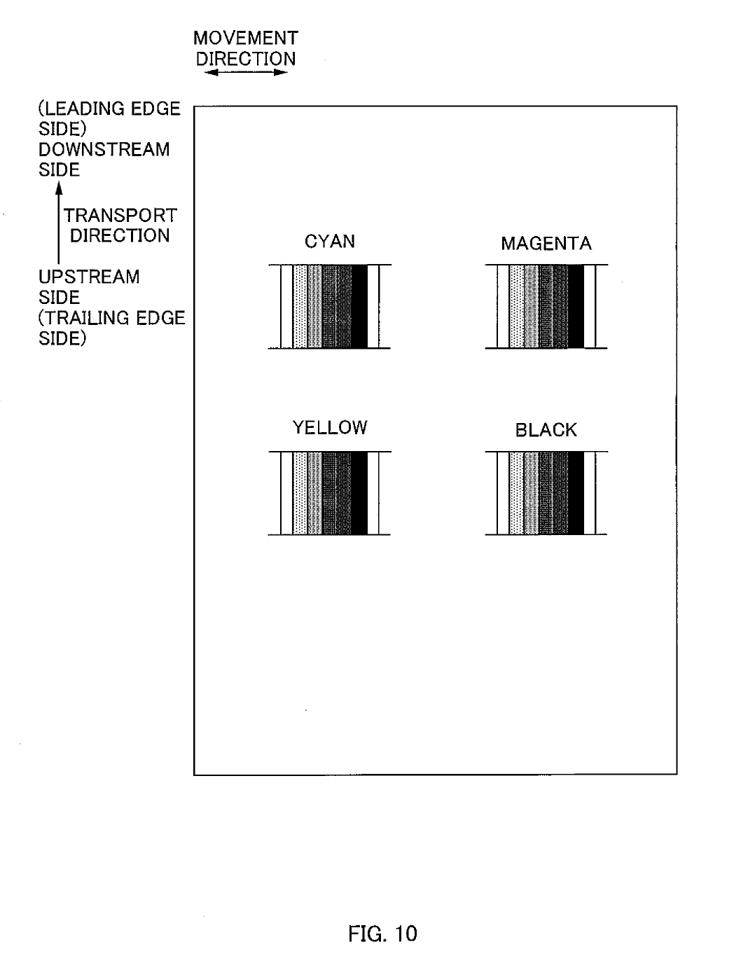

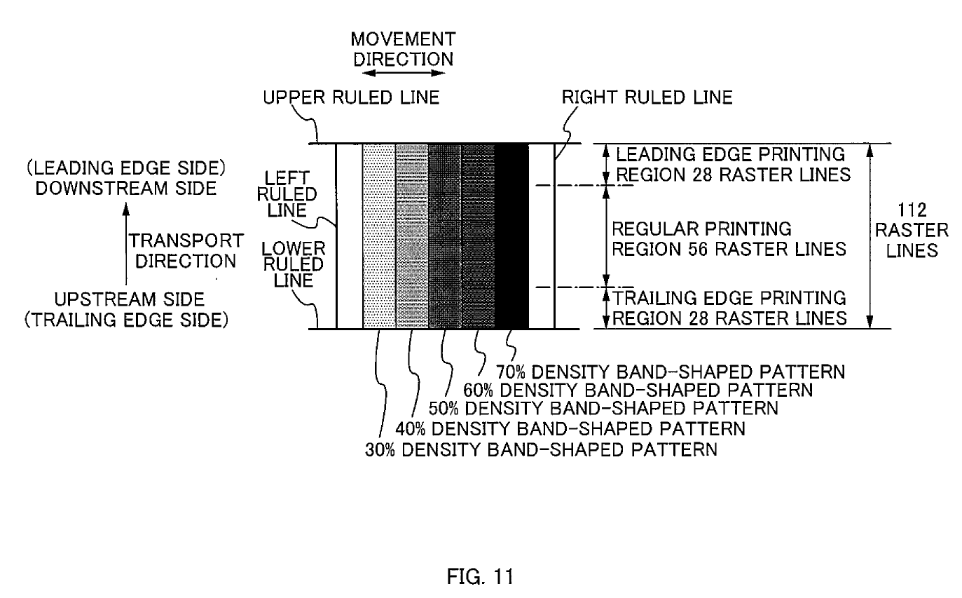

FIG. 10 is an explanatory diagram showing a test pattern. FIG. 11 is an explanatory diagram showing a correction pattern. Four correction patterns are formed in the test pattern for each color. Each correction pattern consists of band-shaped patterns in five density levels, an upper ruled line, a lower ruled line, a left ruled line, and a right ruled line. Each band-shaped pattern is generated from image data of a constant tone value. From the left-end band-shaped pattern to the right side, patterns of a tone value 76 (30% density), a tone value 102 (40% density), a tone value 128 (50% density), a tone value 153 (60% density), and a tone value 179 (70% density), with the density increasing in this order. It should be noted that the five tone values (densities) are referred to as “instructed tone values (instructed density)”, and are expressed using the following symbols: Sa (=76), Sb (=102), Sc (=128), Sd (=153), and Se (=179). Each of the band-shaped patterns is formed using the leading edge printing, the regular printing, and the trailing edge printing, and is therefore made up of raster lines in the leading edge printing region, raster lines in the regular printing region, and raster lines in the trailing edge printing region. In usual printing, several thousands of raster lines are formed in the regular printing region; however, when printing the correction patterns, eight cycles of raster lines are formed in the regular printing region. For simplification of explanation, it is assumed that, in this example, the correction patterns are printed through the printing described in FIG. 7, and each band-shaped pattern consists of a total of 112 raster lines, that is, 28 raster lines in the leading edge printing region, 56 raster lines (7 lines×8 cycles) in the regular printing region, and 28 raster lines in the trailing edge printing region. The upper ruled line is formed by the first raster line (the raster line on the side furthest downstream in the transport direction) that constitutes the band-shaped patterns. On the other hand, the lower ruled line is formed by the last raster line (the raster line on the side furthest upstream in the transport direction) that constitutes the band-shaped pattern.

Next, the inspector places the test pattern printed by the printer 1 on the document platen glass 152 of the scanner 150, closes the upper cover 151 to set the test pattern on the scanner 150. Then, the scanner driver of the computer 110 makes the scanner 150 read the correction patterns (S103). Next, the program for obtaining correction-value in the computer 110 measures the densities of each of the five band-shaped patterns in each row region (S104).

FIG. 12 is a measurement value table summarizing the results of measuring the densities of the five types of band-shaped patterns formed using cyan. As shown, the program for obtaining correction values in the computer 110 creates this measurement value table by associating with each row region the measured values of the densities of the five band-shaped patterns. Measurement value tables are created for the other colors as well. It should be noted that in the explanation below, measurement values for a certain row region in band-shaped patterns having tone values of Sa to Se are indicated respectively as Ca to Ce.

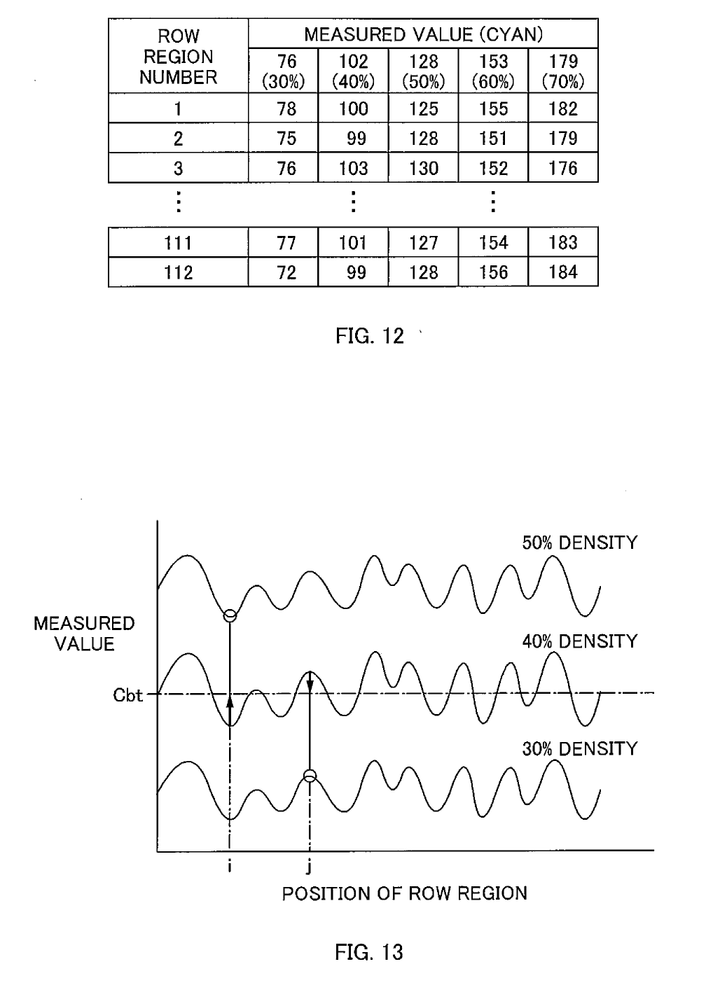

FIG. 13 is a graph showing the measurement values of the cyan band-shaped patterns having 30% density, 40% density, and 50% density, respectively. Even though the band-shaped patterns have been formed at their instructed tone values in a uniform manner, it can be seen that there are differences in density among the row regions. These differences in density among the row regions are causes of density irregularities in a printed image.

In order to eliminate the density irregularities, it is preferable to make uniform the measurement values in each band-shaped pattern. Accordingly, here, a process for making uniform the measurement values in the band-shaped pattern having the tone value Sb (40% density) will be discussed. In this example, the average value Cbt of the measurement values of all the row regions in the band-shaped pattern for the tone value Sb is defined as the target value for 40% density. As for a row region i whose measurement value is lighter than the target value Cbt, it can be considered that correcting the tone value of the row region toward the darker side would be suitable for making the density measurement value come closer to the target value Cbt. On the other hand, as for a row region j whose measurement value is darker than the target value Cbt, it is considered that the tone value may be corrected in a manner to make the density lighter in order for the measurement value to approach the target value Cbt.

Accordingly, the program for obtaining correction values of the computer 110 calculates correction values corresponding to the row regions (S105). Here, explanation will be given regarding calculating a correction value for the instructed tone value Sb in a certain row region. As described below, the correction value of the row region i for the instructed tone value Sb (40% density) shown in FIG. 13 is calculated based on the measurement values for the tone value Sb and tone value Sc (50% density). On the other hand, the correction value of the row region j for the instructed tone value Sb (40% density) is calculated based on the measurement values for the tone value Sb and tone value Sa (30% density).

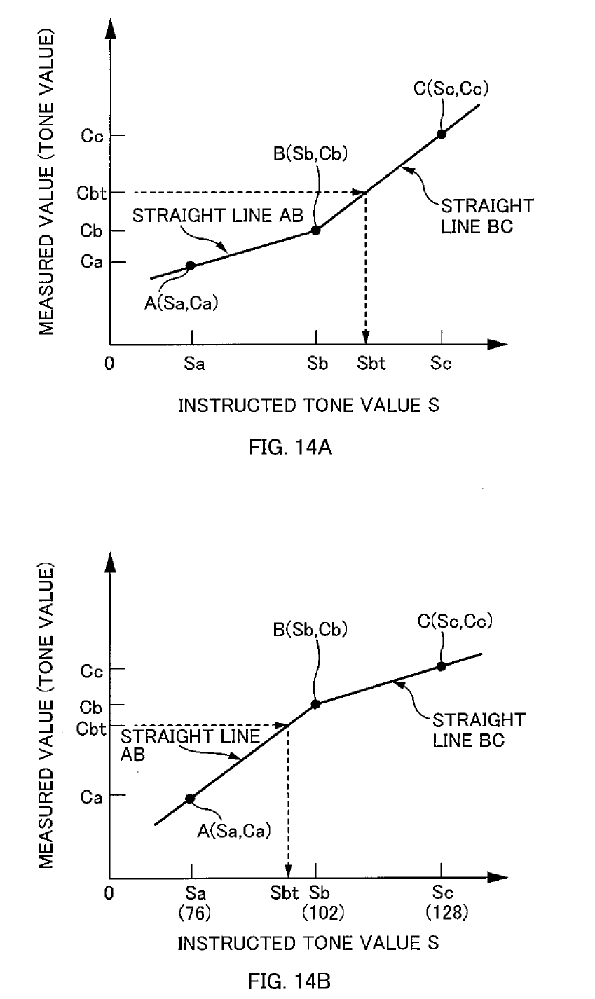

FIG. 14A is a diagram for describing a target instructed tone value Sbt for the instructed tone value Sb in the row region i. In this row region, the measurement value Cb of the density of the band-shaped pattern formed at the instructed tone value Sb indicates a tone value smaller than the target value Cbt. (That is, this row region is lighter than the average density of the band-shaped pattern for 40% density.) If the printer driver makes the printer form a pattern of a density of the target value Cbt in this row region, then it would be suitable for the printer driver to give an instruction based on the target instructed tone value Sbt calculated according to the following expression (linear interpolation based on line BC):

Sbt=Sb+(Sc−Sb)×{(Cbt−Cb)/(Cc−Cb)}

FIG. 14B is a diagram for describing a target instructed tone value Sbt for the instructed tone value Sb in the row region j. In this row region, the density measurement value Cb of the band-shaped pattern formed at the instructed tone value Sb indicates a tone value larger than the target value Cbt (this row region is darker than the average density of the band-shaped pattern for 40% density.). If the printer driver is to make the printer form a pattern of a density corresponding to the target value Cbt in this row region, then it would be suitable for the printer driver to give an instruction based on the target instructed tone value Sbt calculated according to the following expression (linear interpolation based on line A3):

Sbt=Sb−(Sb−Sa)×{(Cbt−Cb)/(Ca−Cb)}

After calculating the target instructed tone value Sbt in this way, the correction value obtaining program calculates a correction value Hb for the instructed tone value Sb in that row region according to the following expression:

Hb=(Sbt−Sb)/Sb

The correction value obtaining program in the computer 110 calculates, for each row region, a correction value Hb for the tone value Sb (40% density). In the same way, the correction value obtaining program calculates, for each row region, a correction value Hc for the tone value Sc (50% density), based on the measurement value Cc and the measurement value Cb or Cd for each row region. Further, in the same way, the correction value obtaining program calculates, for each row region, a correction value Hd for the tone value Sd (60% density), based on the measurement value Cd and the measurement value Cc or Ce for each row region. The program also calculates, for each row region, three correction values (Hb, Hc, and Hd) for the other colors.

In the regular printing region, there are 56 raster lines, and there is regularity for each set of 7 raster lines. This regularity is taken into consideration when calculating the correction values of the regular printing region.

When calculating the correction values for the first row region of the regular printing region (the 29th row region of the entire printing region), the correction value obtaining program uses, as the above-described measurement value Ca, the average value of the measurement values for 30% density of the row regions of eight row regions of 1st, 8th, 15th, 22nd, 29th, 36th, 43rd, and 50th row regions in the regular printing region. Similarly, when calculating the correction values for the first row region of the regular printing region (the 29th row region of the entire printing region), the program uses, as the above-described measurement values Cb to Ce, the respective average values of the measurement values for each density of the row regions of the eight row regions of 1st, 8th, 15th, 22nd, 29th, 36th, 43rd, and 50th row regions in the regular printing region. Based on these measurement values Ca to Ce, the correction values (Hb, Hc, and Hd) of the first row region of the regular printing region are calculated, as described above. In this way, the correction values for each row region in the regular printing region are calculated based on an average of measurement values for each density of eight row regions, which are arranged at an interval of seven row regions. As a result, correction values are calculated only for the 1st to 7th seven row regions, and are not calculated for the 8th to 56th row regions. In other words, the correction values for the 1st to 7th seven row regions in the regular printing region serve as the correction values for the 8th to 56th row regions.

Next, the correction value obtaining program in the computer 110 stores the correction values in the memory 63 of the printer 1 (S106).

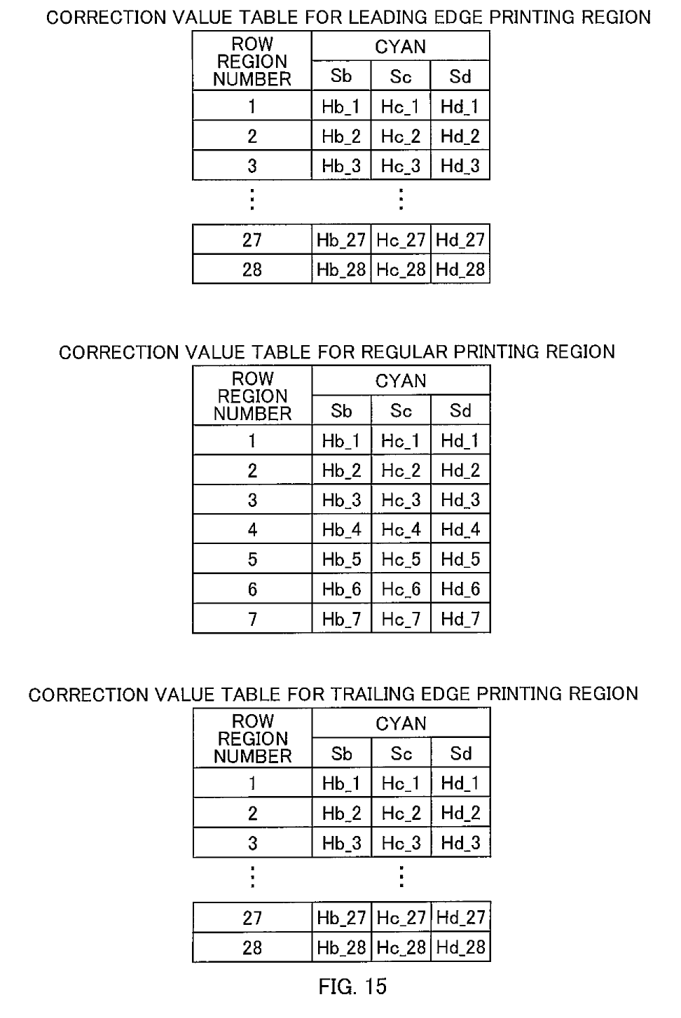

FIG. 15 is an explanatory diagram showing correction value tables for cyan. There are three types of correction value tables: a table for the leading edge printing region, a table for the regular printing region, and a table for the trailing edge printing region. In each table, three correction values (Hb, Hc, and Hd) are associated to each row region. For example, three correction values (Hb_n, Hc_n, and Hd_n) are associated with the n-th row region of each row region. The three correction values (Hb_n, Hc_n, and Hd_n) correspond to the instructed tone values Sb (=102), Sc (=128), and Sd (=153), respectively. It should be noted that the correction value tables for the other colors are configured in the same way.

After storing the correction values in the memory 63 of the printer 1, the correction value obtaining process is finished. Then, the printer 1 and the computer 110 are disconnected, and the printer 1 is shipped from the factory after other inspections on the printer 1 are finished. The printer 1 is shipped with a CD-ROM storing the printer driver.

Regarding Processes by User

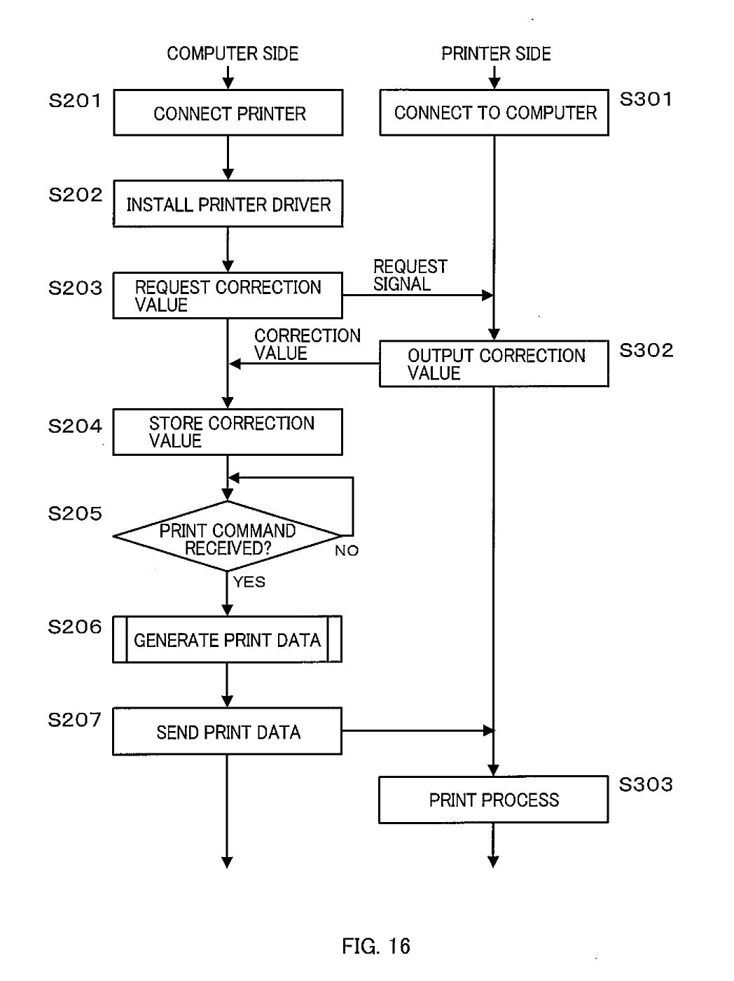

FIG. 16 is a flowchart showing processes performed by a user.

The user that has purchased the printer 1 connects the printer 1 to a computer 110 that he/she owns (which is of course different from the computer in the printer manufacturing factory) (S201, S301). It should be noted that the scanner 150 does not have to be connected to the user's computer 110.

Next, the user sets the CD-ROM packaged with the printer 1 to the record/play device 140 to install the printer driver (S202). The printer driver installed on the computer 110 requests the printer 1 to send the correction values (S203) to the printer 1. In response to this request, the printer 1 sends to the computer 110 the correction value tables stored in its memory 63 (S302). The printer driver stores the correction values sent from the printer 1 in its memory (S204). In this way, the correction value tables are created also on the side of the computer. After processes up to this point are finished, the printer driver stands by until there is a print command from the user (NO at S205).

When the printer driver receives a print command from the user (YES at S205), it generates print data in accordance with the correction values (S206), and sends the print data to the printer 1. The printer 1 then performs the print process in accordance with the print data (S303).

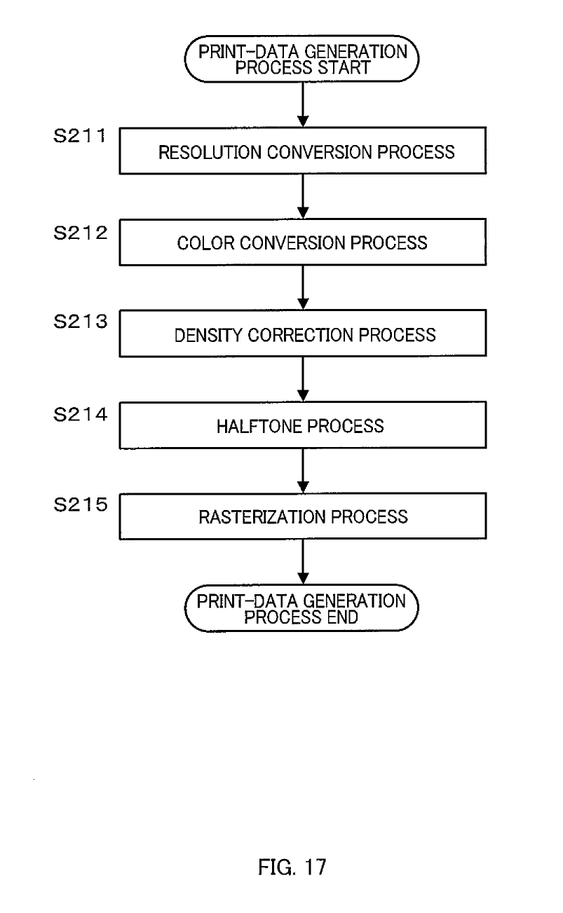

FIG. 17 is a flowchart of print-data generation process. The process is performed by the printer driver.

First, the printer driver performs resolution conversion process (S211). The resolution conversion process is a process for converting the resolution of image data (such as text data and image data) output from the application program to the resolution used at the time of performing printing on paper. For example, when the resolution for when performing printing on paper is instructed as 720×720 dpi, the printer driver converts the image data received from the application program into image data having a resolution of 720×720 dpi. It should be noted that the image data after the resolution conversion process is data (“RGB data”) having 256 tones expressed in the RGB color space.

Next, the printer driver performs color conversion process (S212). The color conversion process is a process for converting the RGB data into CMYK data expressed in the CMYK color space. The color conversion process is performed by the printer driver referencing a table (a “color conversion lookup table LUT”) in which the tone values of the RGB data and the tone values of the CMYK data are associated. Through this color conversion process, the RGB data for each pixel is converted into CMYK data, which corresponds to the ink color. It should be noted that data after the color conversion process is CMYK data having 256 tones expressed in the CMYK color space.

Next, the printer driver performs density correction process (S213). The density correction process is a process for correcting the tone value of each pixel data based on the correction value(s) corresponding to the row region to which that pixel data belongs.

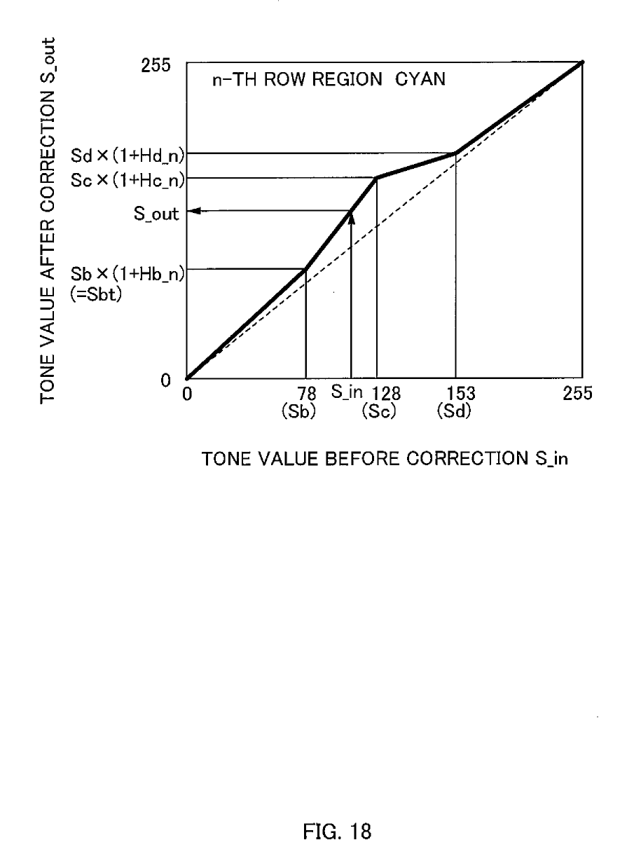

FIG. 18 is an explanatory diagram showing the density correction process for an n-th row region for cyan. FIG. 18 shows correction of a tone value S_in of pixel data of a pixel belonging to the n-th row region for cyan. It should be noted that the tone value after correction is referred to as S_out.

When the tone value S_in of the pixel data before correction is the same as the instructed tone value Sb, the printer driver can form an image at the target density Cbt in the unit region corresponding to that pixel data by correcting the tone value S_in to the target instructed tone value Sbt. That is, if the tone value S_in of the pixel data before correction is the same as the instructed tone value Sb, then it is preferable to correct the tone value S_in (=Sb) to Sb×(1+Hb) using the correction value Hb corresponding to the instructed tone value Sb. Similarly, if the tone value S of the pixel data before correction is the same as the instructed tone value Sc, then it is preferable to correct the tone value S_in (=Sc) to Sc×(1+Hc).

On the contrary, when the tone value S_in before correction is different from the instructed tone value, then the tone value S_out to be output is calculated using linear interpolation as shown in FIG. 18. In the linear interpolation shown in the figure, linear interpolation is performed between the tone values S_out after correction (Sbt, Sct, and Sdt) which correspond to the instructed tone values (Sb, Sc, and Sd). This, however, is not a limitation. For example, it is possible to calculate a correction value H corresponding to the tone value S_in by performing linear interpolation between the correction values (Hb, Hc, and Hd) corresponding to the respective instructed tone values and calculate the tone value after correction as S_in×(1+H) using the calculated correction value H.

As for the pixel data for the 1st to 28th row regions in the leading edge printing region, the printer driver performs the density correction process based on the correction values corresponding to each of the 1st to 28th row regions, which are stored in the correction value table for the leading edge printing region. For example, as for the pixel data for the first row region in the leading edge printing region, the printer driver performs the density correction process based on the correction values (Hb_1, Hc_1, and Hd_1) for the first row region in the correction value table for the leading edge printing.

Similarly, as for the pixel data for the 1st to 7th row regions in the regular printing region (the 31st to 38th row regions in the entire printing region), the printer driver performs the density correction process based on the correction values corresponding to each of the 1st to 7th row regions, which are stored in the correction value table for the regular printing region. Note, however, that even though there are several thousands of row regions in the regular printing region, correction values for only seven row regions are stored in the correction value table for the regular printing region. Accordingly, as for the pixel data for the 8th to 14th row regions in the regular printing region, the printer driver performs the density correction process based on the correction values corresponding to each of the 1st to 7th row regions, which are stored in the correction value table for the regular printing region. In this way, as for the row regions in the regular printing region, the printer driver repeatedly uses, for every set of seven row regions, the correction values corresponding to each of the 1st to 7th row regions. Since there is regularity for each set of seven row regions in the regular printing region, it can be considered that the characteristics regarding density irregularities also repeat at the same cycle. Therefore, by repeatedly using the correction values at the same cycle, the amount of data of correction values to be stored is reduced.

It should be noted that there are only 56 row regions in the regular printing region of the correction pattern. However, the number of row regions in a regular printing region of an image that is printed when the printer is in the hands of a user is much larger than 56, and may amount to several thousands. The trailing edge printing region, which is made up of 28 row regions, is formed on the upstream side in the transport direction (on the trailing edge side of the paper) from the above-described regular printing region.

In the same manner as the leading edge printing region, in the trailing edge printing region, the printer driver performs the density correction process on the pixel data of the 1st to 28th row regions of the trailing edge printing region, based on the correction values corresponding to each of the 1st to 28th row regions stored in the correction value table for the trailing edge printing region.

With the density correction process described above, for the row region that tends to be visually recognized to be dark, the tone values of the pixel data (CMYK data) of the pixels corresponding to that row region are corrected to become lower. On the other hand, as for the row regions that tends to be visually perceived light, the tone values of the pixel data of the pixels corresponding to that row region are corrected to become higher. It should be noted that the printer driver performs the correction process in the same way for the other row regions of other colors as well.

Next, the printer driver performs halftone process (S214). The halftone process is a process in which data of a high number of tones is converted to data of a number of tones that can be formed by the printer. For example, with the halftone process, data indicating 256 tones is converted into one-bit data indicating two tones or two-bit data indicating four tones. In the halftone process, dithering, γ-correction, error diffusion, and so forth, are used to create pixel data such that the printer can form dots in a dispersed manner. When the printer driver performs the halftone process, it references a dither table when using dithering, it references a gamma table when using γ-correction, and it references an error memory for storing diffused errors when using error diffusion. Data subjected to the halftone process has the same resolution (for example, 720×720 dpi) as that of the RGB data described above.

In the present embodiment, the printer driver performs the halftone process with respect to pixel data whose tone value has been corrected through the density correction process. Since a row region that tends to be visually perceived dark has been corrected such that the tone value of the pixel data in that row region becomes smaller, the dot-generation rate of dots that constitute the raster line to be formed in that row region becomes lower. On the other hand, the dot-generation rate becomes higher for a row region that tends to be visually perceived light.

Next, the printer driver performs rasterization process (S215). The rasterization process is a process for changing the matrix-like image data into the order in which they are to be transferred to the printer. Data subjected to the rasterization process are output to the printer as the pixel data included in the print data.

When the printer performs the print process in accordance with the print data generated in this way, the dot-generation rate of the raster line in each row region is changed as shown in FIG. 5C, and the density of the image piece in that row region is corrected, thereby suppressing density irregularities in the entire printed image.

In the description above, the number of nozzles and the number of row regions (number of raster lines) are set to a small number in order to simplify the explanation. In practice, however, the number of nozzles is 180, and the number of row regions in, for example, the leading edge printing region or the trailing edge printing region becomes 360. Note, however, that the processes performed by the correction value obtaining program, the printer driver, etc., are substantially the same.

### Positional Alignment Transport

The printer 1 carries out printing on papers of various sizes (for example A4 size, L size, or the like). However the paper is supplied to the print start position regardless of the paper size. That is, regardless of the paper size, the positional relationship between the head and the paper during leading edge printing (the position relationship between the head and the paper from pass 1 to pass 4) is fixed.

On the other hand, when the size of the paper varies, the length in the transport direction of the paper becomes different. As a result, the positional relationship between the head and the paper when regular printing is finished varies.

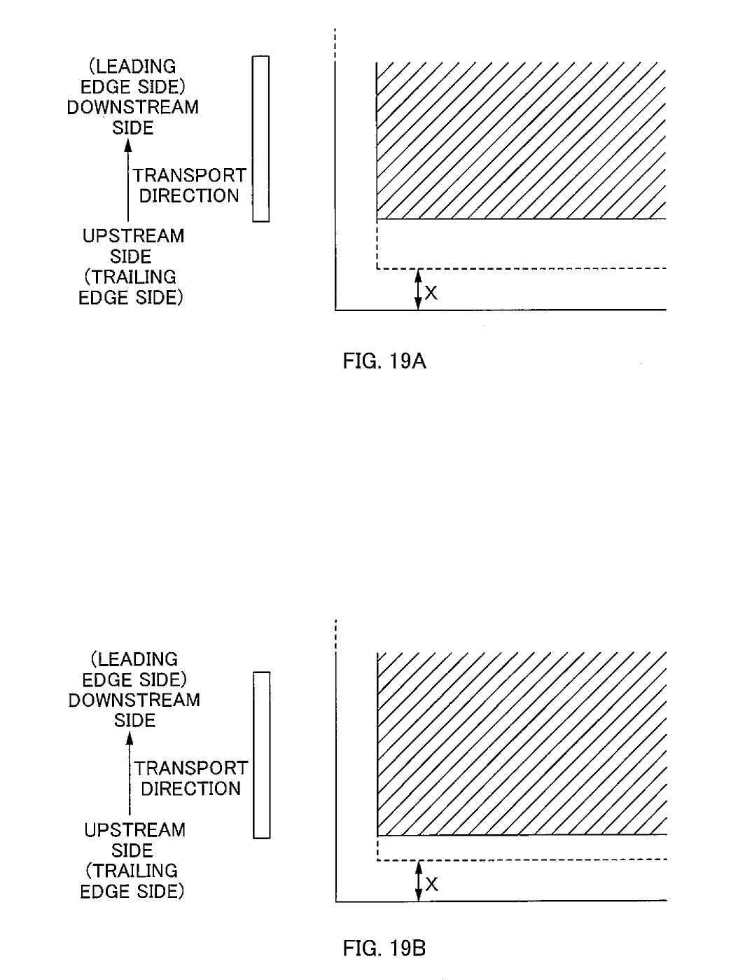

FIG. 19A is an explanatory diagram describing a positional relationship between the head and the trailing edge of the paper when regular printing of A4 size is finished. FIG. 19B is an explanatory diagram describing a positional relationship between the head and the trailing edge of the paper when regular printing of L size is finished. At the left side of each figure is shown the head position with respect to the paper when regular printing is finished. At the right side of each figure is shown the paper position. The diagonally shaded region on the paper indicates a region already printed. The region shown by the dotted line in the upstream side in the transport direction from the diagonally shaded region (the trailing edge side of the paper, the lower side in FIGS. 19A and 19B) indicates the region to be printed by the trailing edge printing. In the case of either paper size, printing is carried out by leaving a predetermined amount of margin X at the trailing edge side of the paper.

As it is recognized by comparing FIGS. 19A and 19B, the positional relationship between the head and the paper when the regular printing is finished varies when the paper size varies. Specifically, in the case of FIG. 19B, the position of the head with respect to the paper is more on the trailing edge side of the paper when regular printing is finished than in the case of FIG. 19A. In other words, in the case of FIG. 19B the paper is positioned more on the downstream side in the transport direction when regular printing is finished than in the case of FIG. 19A.

Next, a case where a positional alignment transport is not carried out is described. In the case where the positional alignment transport is not carried out, the transport amount in a transport process carried out between the final pass of regular printing and the first pass of trailing edge printing becomes a fixed transport amount. Here, the transport amount of this transport process is given as F (in the case where there are eight nozzles, F=7·D, and in the case where there are 180 nozzles, F=179·D). As described below, in the case where the positional alignment transport is not carried out, the positional relationship between the head and the paper during trailing edge printing varies when the paper size varies.

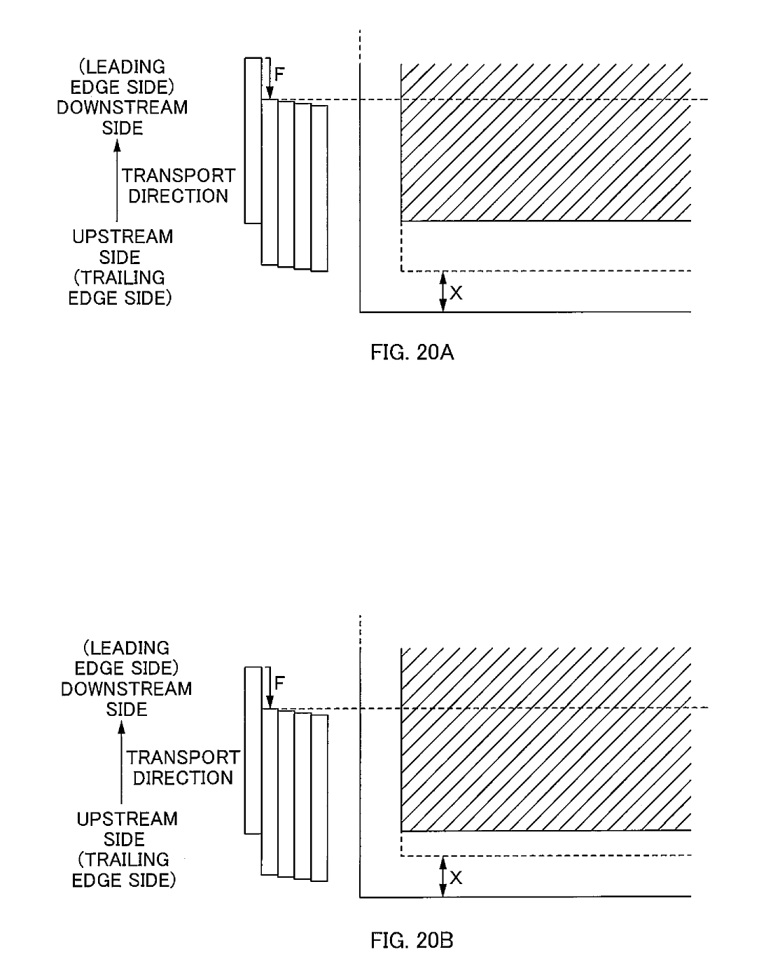

FIG. 20A is an explanatory diagram describing a case where trailing edge printing is carried out on A4 size paper. FIG. 20B is an explanatory diagram describing a case where trailing edge printing is carried out on an L size paper without performing the positional alignment transport after FIG. 19B. In the trailing edge printing, passes are carried out four times while repeating a very small transport as shown in FIG. 7. It should be noted that in the case of FIG. 20A (in the case of the A4 size paper), the trailing edge printing is carried out by ejecting ink also from nozzles on the upstream side in the transport direction of the head, as shown in the trailing edge printing of FIG. 7, but in the case of FIG. 20B (in the case of the L size paper), the trailing edge printing is carried out such that nozzles positioned on the upstream side in the transport direction from the trailing edge printing region do not eject ink.

As recognized by comparing FIGS. 19A and 19B, the positional relationship between the head and the paper when starting the trailing edge printing varies when the paper size varies. Specifically, in the case of FIG. 19B, the position of the head with respect to the paper is more on the trailing edge side of the paper when starting the trailing edge printing than in the case of FIG. 19A. Furthermore, in the case of FIG. 20B, the position of the head with respect to the paper is more on the trailing edge side when the trailing edge printing is finished than in the case of FIG. 20A. In other words, in the case of FIG. 20B, the paper is positioned more on the downstream side in the transport direction when the trailing edge printing is finished than in the case of FIG. 20A.

Next, a problem in the cases where the positional relationship between the head and the paper varies according to the paper size is described.

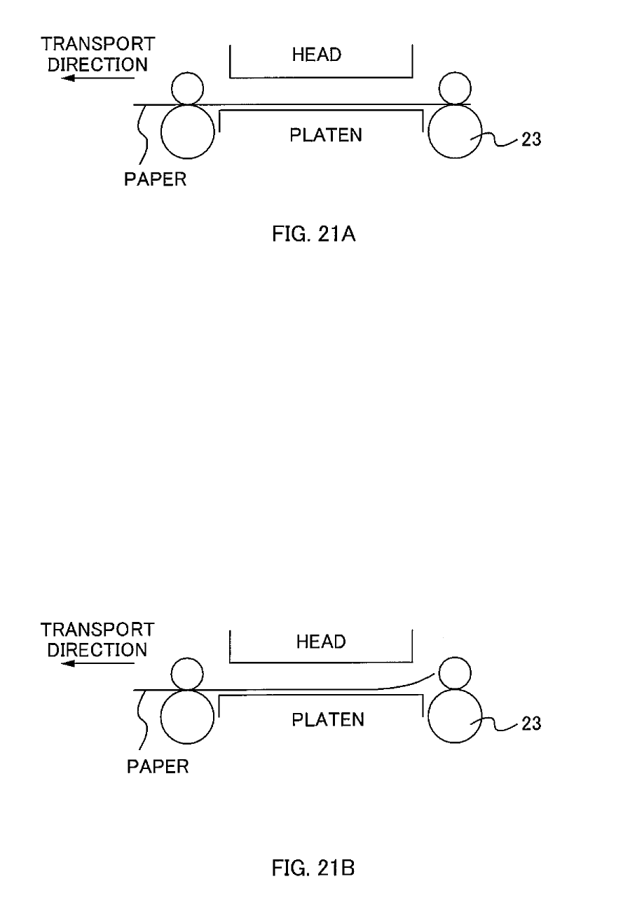

FIG. 21A is an explanatory diagram describing the trailing edge printing in FIG. 20A. In this case, the trailing edge of the paper is positioned on the upstream side in the transport direction from the transport roller 23. Thus, the trailing edge printing is carried out in a state in which the paper is sandwiched in two locations, these being on the transport roller 23 side and the discharge roller 25 side.

FIG. 21B is an explanatory diagram describing the trailing edge printing in FIG. 20B. In this case, the trailing edge of the paper is positioned on the downstream side in the transport direction from the transport roller 23. Thus, the trailing edge printing is carried out in a state in which the paper is sandwiched only on the discharge roller 25 side. In such a state, since the trailing edge of the paper is a free edge there is a risk that the trailing edge may rise up from the platen 24. As a result, the image quality of the trailing edge printing region of FIG. 20B may differ from the image quality of the trailing edge printing region of FIG. 20A. Then, the density irregularities in the trailing edge printing region may not be corrected appropriately even if the above-described test pattern is generated on the A4 size paper to obtain the correction values for the trailing edge printing region, and such correction values are used when printing the L size paper.

Thus, in the present embodiment, the positional alignment transport is carried out according to the paper size.

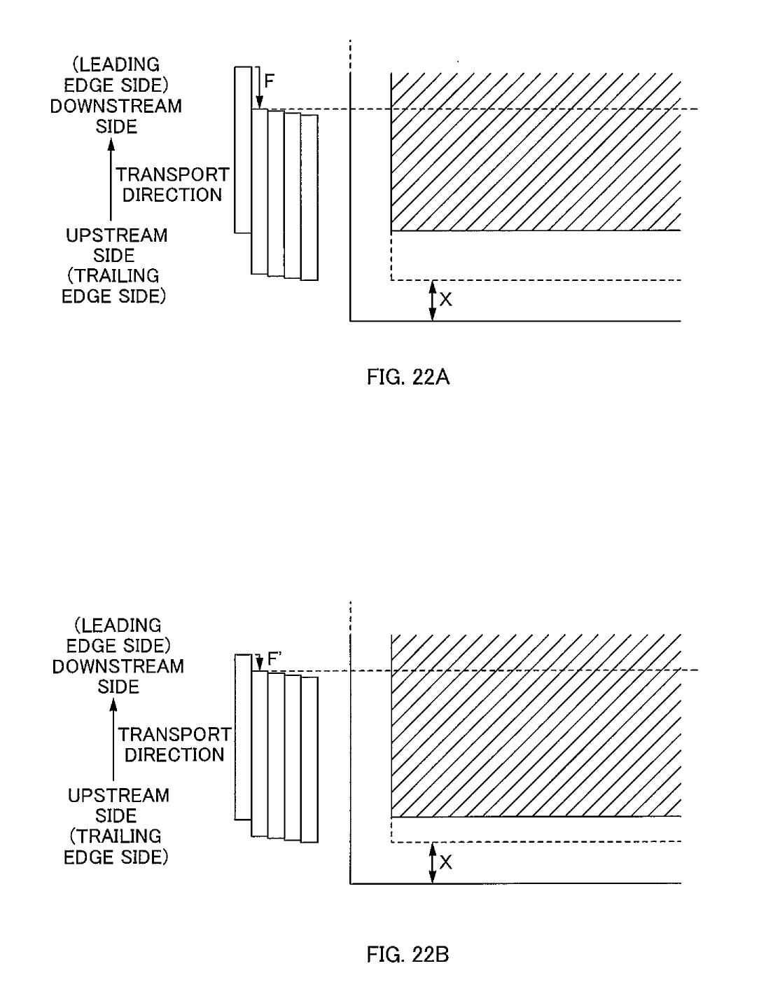

FIGS. 22A and 22B are explanatory diagrams describing the positional alignment transport. FIG. 22A is an explanatory diagram describing a case where the trailing edge printing is carried out on the A4 size paper, and is equivalent to FIG. 20A. FIG. 22B is an explanatory diagram describing a case where the trailing edge printing is carried out by performing the positional alignment transport for the L size paper. In FIG. 22B, the positional relationship between the head and the paper when the regular printing is finished is same as that of FIGS. 19B and 20B.

Comparing FIGS. 22A and 22B, there is a difference between the transport amounts of the transport process carried out between the last pass of the regular printing and the first pass of the trailing edge printing. In this way, the positional relationship between the head and the paper when the trailing edge printing is finished is the same in FIGS. 22A and 22B. In other words, the transport amounts are varied in the transport process carried out between the last pass of the regular printing and the first pass of the trailing edge printing so that the positional relationship between the head and the paper is the same when the trailing edge printing is finished. This transport process is referred to as “positional alignment transport”.

### Correction of Density Irregularities in the Trailing Edge Printing Region when Carrying Out Positional Alignment Transport

Regarding State of the Trailing Edge Printing Region

Before describing density irregularity corrections in the trailing edge printing region when performing the positional alignment transport, a state of the trailing edge printing region when performing the positional alignment transport is described.

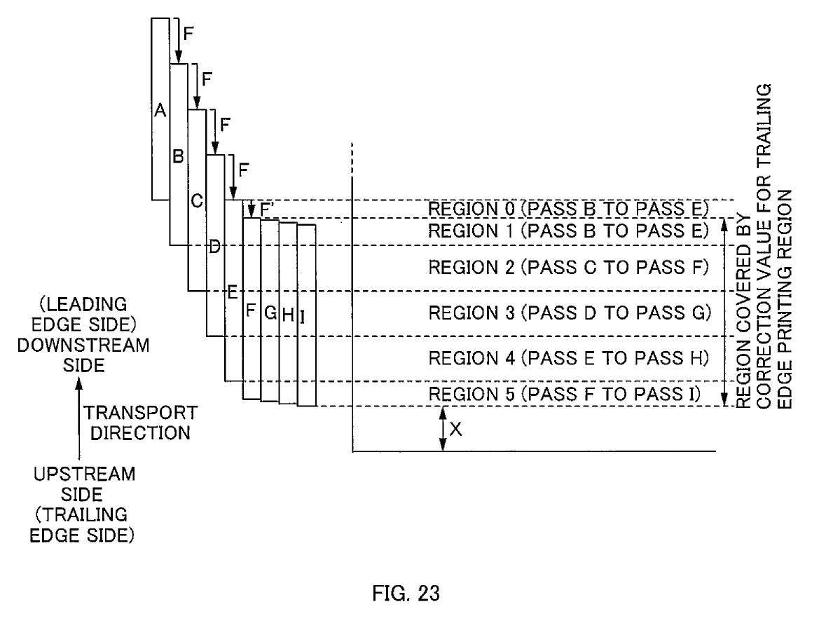

FIG. 23 is an explanatory diagram describing a state of the trailing edge printing region when performing the positional alignment transport.

In the left side of FIG. 23, the position of the head with respect to the paper is described. In the following description, for example, a “pass A” designates a dot forming process carried out by the head indicated by the alphabetic letter “A” in the diagram. Passes A to E are passes in the regular printing. Passes F to I are passes in the trailing edge printing. The positional alignment transport is carried out in the transport process performed between pass E and pass F. The transport amount at this time is a transport amount F′ which is different from the transport amount F of the regular printing.

In the right side of FIG. 23, the position of the paper is described. Furthermore, in the right side of FIG. 23, a “region covered by the correction values for the trailing edge printing region” is shown, and when there are 28 correction values for the trailing edge printing region, 28 raster lines are in this region (when there are 180 nozzles, there are 360 raster lines in this region).

The region on the downstream side in the transport direction from “region 1” in FIG. 23 (upper side in FIG. 23) is the regular printing region. That is, the raster lines in this region are formed by the regular printing. For example, a “region 0” in FIG. 23 is formed by raster lines in passes B to E and all the raster lines are formed by the regular printing.

The raster lines in the “region 1” in FIG. 23 are formed by passes B to E. That is, when performing the positional alignment transport, the raster lines of this region are formed by the regular printing even though the region is in the range covered by the correction values for the trailing edge printing region.

The raster lines in a “region 2” to a “region 4” in FIG. 23 are a mixture of raster lines formed by regular printing and raster lines formed by trailing edge printing. For example, in the “region 2”, since the raster lines are formed in pass C to pass F, three of the four raster lines are formed by the regular printing and one raster line is formed by the trailing edge printing region. Furthermore, in a “region 3”, since the raster lines are formed in pass D to pass G, two of the four raster lines are formed by the regular printing and two raster lines are formed by the trailing edge printing region. Furthermore, in a “region 4”, since the raster lines are formed in pass E to pass H, one of the four raster lines is formed by the regular printing and three raster lines are formed by the trailing edge printing.

The raster lines in a “region 5” in FIG. 23 are raster lines that are formed in pass F to pass I. Thus, the raster lines in this region are all formed by the trailing edge printing.

### Regarding Density Irregularity Correction in the Trailing Edge Printing Region when Carrying Out Positional Alignment Transport

Next, description is given regarding the density irregularity correction in the trailing edge printing region when carrying out the positional alignment transport. Here, in order to simplify description as in the case of FIG. 8, description is given by using eight nozzles (in reality there are 180 nozzles).

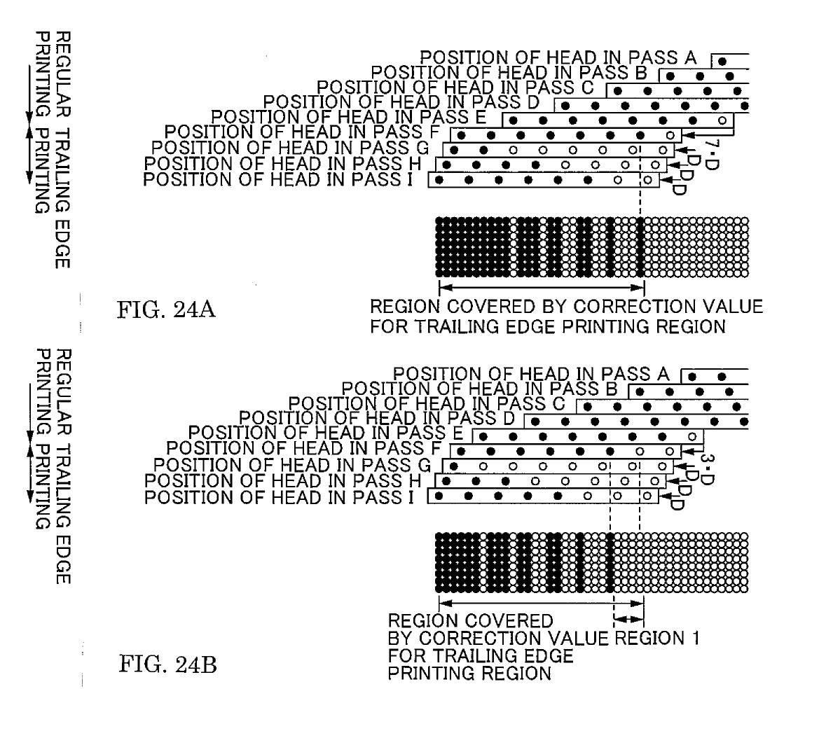

FIG. 24A is an explanatory diagram of the trailing edge printing on A4 size paper. FIG. 24B is an explanatory diagram of the trailing edge printing on L size paper. In FIGS. 24A and 24B, the trailing edge printing is carried out in pass F to pass I. Of the raster lines on the right side of FIGS. 24A and 24B, the raster line shown by a black circle is a raster line formed by the trailing edge printing. Furthermore, in FIG. 24B, the positional alignment transport is carried out in the transport process carried out between pass E and pass F, and the transport amount at this time is the transport amount 3·D, which is different from the transport amount 7·D in the regular printing.

The description of the density irregularity correction for the trailing edge printing region in the case of FIG. 24A is omitted, since it is as described before.

In FIG. 24B, the four raster lines shown as the “region 1” are raster lines formed in the “region 1” of FIG. 23. That is, these four raster lines are raster lines formed by the regular printing although the region is covered by the correction value for the trailing edge printing region.

The range of the “region 1” corresponds to a difference between the transport amount during the regular printing and the transport amount during the positional alignment transport. Here, the transport amount during the regular printing is 7·D and the transport amount of the positional alignment transport is 3·D, and therefore the range of the “region 1” is 4·D. That is, the range of the “region 1” is the amount of four raster lines.

If the correction values of each of row regions 1 to 4 in the correction value table for the trailing edge printing region in FIG. 15 were applied to the row regions corresponding to the four raster lines of the “region 1”, then the density irregularities could not be corrected appropriately. This is because the four raster lines of the “region 1” in FIG. 24B are formed in a condition different from the 1st to 4th raster lines of the trailing edge printing region of the test pattern.

On the other hand, the four raster lines of the “region 1” are formed by the regular printing, and therefore have the same regularity in the manner raster lines are arranged as in the regular printing region. Specifically, the four raster lines of the “region 1” are formed, from the top of FIG. 24B, by nozzle #8 (pass B), nozzle #3 (pass E), nozzle #5 (pass D), and nozzle #7 (pass C).

Consequently, in the present embodiment, the correction values for the regular printing are applied to the row regions corresponding to the four raster lines of the “region 1”. The seven correction values of row region numbers 1 to 7 in the correction value table for the regular printing in FIG. 15 correspond to row regions in which raster lines are formed, in order of nozzle #3, nozzle #5, nozzle #7, nozzle #2, nozzle #4, nozzle 46, and nozzle #8. For this reason, the printer driver applies, in order from the top of FIG. 24B, the correction values of the row region numbers 7, 1, 2, and 3 of the correction value table for the regular printing in FIG. 15 respectively, to the four row regions corresponding to the four raster lines of the “region 1”. In this way, the image quality of the “region 1” can be improved in the present embodiment.

Next, the density irregularity correction in the row regions corresponding to raster lines other than the “region 1” is described.

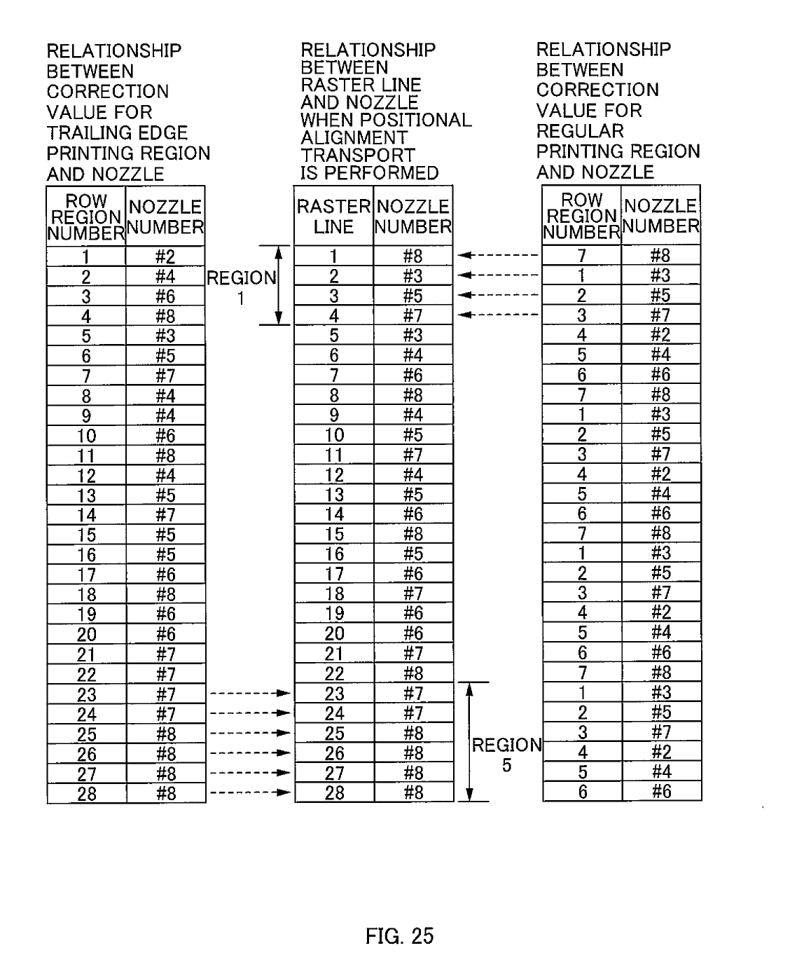

The table in the center of FIG. 25 shows a relationship between the 28 raster lines of the “region covered by the correction values for the trailing edge printing region” in FIG. 24B, and the nozzles by which each raster line is formed. Each raster line is assigned a number that becomes younger the further downstream the nozzle is in the transport direction (leading edge side of the paper). For example, it is shown in the table that the four raster lines of aforementioned “region 1” are formed by nozzle #8, nozzle #3, nozzle #5, and nozzle #7 in this order.

The table on the right side of FIG. 25 shows a relationship between the correction values for the regular printing region and the nozzles. For example, the seven correction values of the row region numbers 1 to 7 in the correction value table for the regular printing correspond to the row regions in which raster lines are formed by nozzle #3, nozzle #5, nozzle #7, nozzle #2, nozzle #4, nozzle 46, and nozzle #8 respectively. It should be noted that it is also shown in the table that the correction values of row region numbers 7, 1, 2, and 3 are applied to the four row regions that correspond to the four raster lines of the above-described “region 1” respectively.

The table on the left side of FIG. 25 shows a relationship between the correction values for the trailing edge printing region and the nozzles. In other words, this table shows a relationship between the 28 raster lines of the trailing edge printing region in the test pattern and the nozzles by which each raster line is formed. For example, the 1st raster line in the trailing edge printing region is formed by nozzle #2 (also refer to FIG. 7).

The six raster lines (23rd to 28th raster lines) of the “region 5” are all formed by the trailing edge printing. Thus, the nozzles that form these six raster lines and the nozzles that correspond to 23rd to 28th correction values for the trailing edge printing region are in agreement. For this reason, the printer driver applies the 23rd to 28th correction values for the trailing edge printing region respectively to the row regions corresponding to the “region 5”. In this way, the image quality of the “region 5” can be improved in the present embodiment. It should be noted that if the correction values for the regular printing region were applied to the row regions corresponding to the “region 5”, the density irregularities would not be corrected appropriately because the corresponding nozzles are completely different.

In the present embodiment, 5th to 22nd correction values for the trailing edge printing region are applied to the 18 row regions corresponding to the “region 2” to the “region 4”. In this way, although the density irregularities in all 18 row regions may not be able to be corrected, it becomes possible to achieve a remedy for density irregularities.

However, it is not necessary to apply the correction values for the trailing edge printing region to all the 18 row regions corresponding to the “region 2” to the “region 4”. For example, the correction values for the regular printing region may be applied to the row regions corresponding to the “region 2”. There is a tendency for corresponding nozzles to match for correction values for the regular printing region applied to row regions further on the downstream side in the transport direction of the 18 row regions corresponding to the “region 2” to the “region 4”, and therefore it becomes possible to achieve a remedy for density irregularities. Conversely, since there is a tendency for corresponding nozzles to match for correction values for the trailing edge printing region applied to row regions further on the upstream side in the transport direction, it becomes possible to achieve a remedy for density irregularities.

Furthermore, it is possible that the correction values for the regular printing region and the correction values for the trailing edge printing region are applied to the row regions corresponding to the “region 2” to the “region 4” while being weighted respectively. In this case, it is preferable that the weighting on the correction values for the regular printing region is increased for row regions further on the downstream side in the transport direction of the 18 row regions corresponding to the “row region 2” to the “row region 4”. Conversely, it is preferable that the weighting on the correction values for the trailing edge printing region is increased for row regions further on the upstream side in the transport direction.

For example, for the row regions of the “region 2”, a ¾ weighting is applied to the correction values for the regular printing region and a ¼ weighting is applied to the correction values for the trailing edge printing region, and a sum of these is applied as the correction values. Furthermore, for the row regions of the “region 3”, a 2/4 weighting is applied to the correction values for the regular printing region and a 2/4 weighting is applied to the correction values for the trailing edge printing region, and a sum of these is applied as the correction values. For the row regions of the “region 4”, a ¼ weighting is applied to the correction values for the regular printing region and a ¾ weighting is applied to the correction values for the trailing edge printing region, and a sum of these is applied as the correction values. In this way, it is possible to achieve a remedy for density irregularities.

### Other Embodiments

The foregoing embodiment is for the purpose of elucidating the present invention, and is not to be interpreted as limiting the present invention. The invention can of course be altered and improved without departing from the gist thereof, and includes functional equivalents.

### CONCLUSION

(1) In the above-described printing method, first, the test pattern is formed (see S102 in FIG. 9). At this time, the printer 1 forms a plurality of raster lines by the regular printing (an example of a first printing) in the regular printing region (an example of a first printing region) and the trailing edge printing region (an example of a second printing region that is positioned on the trailing edge side of the medium from the first printing region). Next, the printer 1 transports the paper (an example of the medium) by a predetermined transport amount after the regular printing. The predetermined transport amount is 7·D in the case where there are eight nozzles, and 179·D in the case where there are 180 nozzles. Then the printer 1 forms the plurality of raster lines in the trailing edge printing region by the trailing edge printing (refer to FIGS. 7 and 11).

Next, the scanner 150 reads the test pattern (refer to S103 in FIG. 9).

Next, the computer 110 obtains a plurality of second printing region correction values each corresponding to the plurality of raster lines formed in the trailing edge printing region based on a reading result of the scanner 150 (see S104 to S106 in FIG. 9). In the case where there are eight nozzles, 28 raster lines are formed in the trailing edge printing region, and therefore there are 28 second printing region correction values. In the case where there are 180 nozzles, 360 raster lines are formed in the trailing edge printing region, and therefore there are 360 correction values for the second printing region.

Then, when the user carries out printing on the paper, the printer driver corrects the pixel data of the row regions corresponding to each of the correction values based on those correction values (refer to S206 in FIG. 16, S213 in FIG. 17, and FIG. 18), then forms raster lines on the paper by the regular printing and the trailing edge printing based on the corrected pixel data (S303 in FIG. 16). In this way, the densities are corrected in the print image constituted by 28 raster lines in the trailing edge printing region (in the case where there are eight nozzles).

Incidentally, when the transport amount of the transport process carried out between the regular printing and the trailing edge printing when forming the print image and the transport amount of the transport process carried out between the regular printing and the trailing edge printing when printing the test pattern are different, the density irregularities cannot be corrected appropriately even if the correction values for the trailing edge printing region are each applied to all the row regions of the trailing edge printing region. For example, even if the correction values for the trailing edge printing region are applied to the row region of the “region 1” in FIG. 23, the density irregularities cannot be corrected appropriately and in fact there is a risk of carrying out inappropriate corrections.

Accordingly, in the above-described printing method, the printer driver is configured to not correct the row regions of the “region 1” in FIG. 23 based on the correction values for the trailing edge printing region. Specifically, of the correction values for the trailing edge printing region, the correction values of row region numbers 1 to 4 are not used. In this way, it is possible to avoid carrying out inappropriate corrections.

(2) In the above-described printing method, the positional alignment transport is carried out according to the size of the paper on which the print image is to be formed. When the positional alignment transport is carried out, the transport amount of transport carried out between the regular printing and the trailing edge printing becomes shorter than the transport amount during the regular printing (refer to FIG. 22B). When carrying out the positional alignment transport in this manner, it is particularly effective not to use the correction values of the row region numbers 1 to 4 of the correction values for the trailing edge printing region.

However, that it is effective not to use the correction values for the row region numbers 1 to 4 of the trailing edge printing region is not limited to a case in which the positional alignment transport is carried out. For example, even for a reason other than the positional alignment transport, if the transport amount of the transport carried out between the regular printing and the trailing edge printing is shortened by 4·D than the transport amount during the regular printing, it is effective not to use the correction values for the row region numbers 1 to 4 of the trailing edge printing region.

(3) In the above-described printing method, the printer 1 is provided with the transport roller 23 (an example of a transport member) for transporting the paper. As shown in FIGS. 21A and 21B, if the positional relationship between the paper and the transport roller 23 when the trailing edge printing is finished varies, the image quality of the trailing edge printing region varies.

Accordingly, in the above-described printing method, the positional relationship between the paper and the transport roller 23 when the trailing edge printing is finished is kept the same regardless of the size of the paper by carrying out the positional alignment transport. In this way, the correction values corresponding to the row regions of the trailing edge side of the correction values for the trailing edge printing region (for example, the correction values for row region numbers 23 to 28 of the trailing edge printing region in FIG. 25) can be applied to the papers of different sizes.

It should be noted that in the foregoing description, the positional relationship between the paper and the transport roller 23 when trailing edge printing is finished is kept the same regardless of the size of the paper, but there is no limitation to this. Even if the positional relationship between the paper and the transport roller 23 when the trailing edge printing is finished is not precisely the same, it is sufficient to just arrange the positional relationship so that the trailing edge of the paper when the trailing edge printing is finished does not pass the transport roller 23.

(4) In the foregoing description, description was given of carrying out the positional alignment transport in the case of L size paper, however, even in the case of the paper of another size, the positional alignment transport is carried out by the transport amount corresponding to that paper. In this case, the region corresponding to the “region 1” in FIG. 23 (that is, the region in which the regular printing is carried out although the range is covered by the correction values for the trailing edge printing region) becomes wider for shorter transport amounts of the positional alignment transport. Consequently, it is recommended that the number of the correction values for the trailing edge printing region not used in correcting density irregularities is increased for shorter transport amounts of the positional alignment transport.

(5) In the above-described printing method, the correction values for the regular printing region are applied to the 1st to 4th row regions of the trailing edge printing region instead of using the correction values for the row region numbers 1 to 4 of the trailing edge printing region. In this way, correction can be carried out appropriately on the row regions of the “region I” in FIG. 23.

(6) In the above-described printing method, the correction values corresponding to the four raster lines positioned on the downstream side (the regular printing region side) in the transport direction of the 28 raster lines formed in the trailing edge printing region are not used when carrying out the positional alignment transport. This is because, when the positional alignment transport is carried out, the density irregularities cannot be corrected appropriately when each correction values for the trailing edge printing region are applied further on the downstream side of the trailing edge printing region in the transport direction.

(7) With the above-described printer driver and correction value obtaining program, the printer 1 (an example of a printing apparatus) prints the test pattern, the scanner reads the test pattern, the computer 110 (an example of a control device for controlling the printing apparatus) obtains correction values, and the computer 110 corrects the densities of the print image.

And the above-described printer driver is configured not to perform correction on the row regions of the “region 1” in FIG. 23 based on the correction values for the trailing edge printing region. Specifically, of the correction values for the trailing edge printing region, the correction values of the row region numbers 1 to 4 are not used. In this way, it is possible to avoid carrying out inappropriate corrections.

(8) The above-described printing system 100 is provided with the printer 1, the scanner 150, and the computer 110. However, the printing system 100 is not limited to this. The printing system may be achieved by a multifunction machine integrally having a printer function of the printer 1, a scanner function of the scanner 150, and a function of the printer driver. The foregoing embodiments can be achieved by such single multifunction machine.

What is claimed is:

1. A printing method, comprising:
forming a test pattern by forming a plurality of dot rows using a first printing in a first printing region and a second printing region that is positioned at a trailing edge side of a medium from the first printing region, transporting the medium by a predetermined transport amount after the first printing, and forming a plurality of dot rows using a second printing in the second printing region;
reading the test pattern with a scanner;
obtaining a plurality of second printing region correction values respectively corresponding to the plurality of dot rows formed in the second printing region based on a reading result of the scanner; and
correcting densities of a print image constituted by a plurality of dot rows of the second printing region by correcting data corresponding to the second printing region correction values based on the second printing region correction values and forming the dot rows using the first printing and the second printing based on the corrected data,
wherein in forming the print image, if a transport amount of transport carried out between the first printing and the second printing is set shorter than the predetermined transport amount, data corresponding to a portion of correction values of the plurality of second printing region correction values is not corrected based on the portion of the correction values.

2. A printing method according to claim 1,
wherein the transport amount of transport to be carried out between the first printing and the second printing becomes shorter than the predetermined transport amount corresponding to a size of a medium on which the print image is to be formed.

3. A printing method according to claim 2,
including a transport member for transporting the medium,
wherein a positional relationship between the medium and the transport member when the second printing is finished in forming the print image is identical regardless of the size of the medium.

4. A printing method according to claim 1,
wherein the number of the portion of the correction values increases as the transport amounts of transport to be carried out between the first printing and the second printing become shorter than the predetermined transport amount.

5. A printing method according to claim 1,
wherein first printing region correction values corresponding to dot rows formed in the first printing region are obtained based on the reading result of the scanner, and
data corresponding to the portion of the correction values is corrected based on the first printing region correction values instead of the portion of the correction values.

6. A printing method according to claim 5,
wherein the portion of the correction values are the correction values corresponding to dot rows positioned on the first printing region side of a plurality of dot rows formed in the second printing region.

7. A storage medium storing a program, the program that:
makes a printing apparatus form a test pattern by forming a plurality of dot rows using a first printing in a first printing region and a second printing region that is positioned at a trailing edge side of a medium from the first printing region, transport the medium by a predetermined transport amount after the first printing, and form a plurality of dot rows by a second printing in the second printing region;
makes a scanner read the test pattern;
makes a control device that controls the printing apparatus obtain a plurality of second printing region correction values respectively corresponding to the plurality of dot rows formed in the second printing region based on a reading result of the scanner; and
makes the control device correct densities of a print image constituted by a plurality of dot rows of the second printing region by correcting data corresponding to the second printing region correction values based on the second printing region correction values and form the dot rows using the first printing and the second printing based on the corrected data,
wherein in forming the print image, if a transport amount of transport carried out between the first printing and the second printing is set shorter than the predetermined transport amount by the printing apparatus, data corresponding to a portion of correction values of the plurality of second printing region correction values is not corrected based on the portion of the correction values.

8. A printing system, comprising:
a printing apparatus, a scanner, and a control device that controls the printing apparatus,
wherein the printing apparatus forms a test pattern by forming a plurality of dot rows using a first printing in a first printing region and a second printing region that is positioned at a trailing edge side from the first printing region, transporting a medium by a predetermined transport amount after the first printing, and forming a plurality of dot rows using a second printing in the second printing region,
the scanner reads the test pattern,
the control device obtains a plurality of second printing region correction values respectively corresponding to the plurality of dot rows formed in the second printing region based on a reading result of the scanner, and
the control device corrects data corresponding to the second printing region correction values based on the second printing region correction values, and the printing apparatus corrects densities of a print image constituted by a plurality of dot rows of the second printing region by forming the dot rows using the first printing and the second printing based on the corrected data,
wherein in forming the print image, when a transport amount of transport to be carried out between the first printing and the second printing in the printing apparatus is set shorter than the predetermined transport amount, data corresponding to a portion of correction values of the plurality of second printing region correction values is not corrected based on the portion of the correction values.
